(19) United States
(12) Patent Application Publication
(10) Pub. No.: US 2002/0029094 A1
(43) Pub. Date: Mar. 7, 2002

(54) Three-dimensional molding apparatus

(75) Inventor: Jun Koreishi, Susono-shi (JP)

Correspondence Address: McDERMOTT, WILL & EMERY, 600 13th Street, N.W., Washington, DC, 20005, US

(73) Assignee: MINOLTA CO., LTD.

(21) Appl. No.: 09/941,608

(22) Filed: Aug. 30, 2001

(30) Foreign Application Priority Data
Aug. 30, 2000 (JP) P2000-261328

(51) Int. Cl. B29C 39/00; G06F 19/00; B41J 2/01; B22F 1/00

(52) U.S. Cl. 700/197; 700/98; 700/118; 700/166; 347/1; 419/1

(57) ABSTRACT

A data generating apparatus (1) adds feel information to shape data for an object to be molded in an STL data generating section (1a). Then, a data processing apparatus (10) generates molding data for reproducing shape and feel of the object to be molded, and the molding data is supplied to a three-dimensional molding apparatus (20). The three-dimensional molding apparatus (20) performs molding on the basis of the molding data obtained from the data processing apparatus (10). The resulting three-dimensional molded matter faithfully reproduce not only the shape but also the feel of the object to be molded. In this way, the present invention was made to generate a three-dimensional molded matter which faithfully reproduces feel of the object.

This application is based on application Ser. No. 2000-261328 filed in Japan, the contents of which are hereby incorporated by reference.

### BACKGROUND OF THE INVENTION

1. Field of the Invention

The present invention relates to a three-dimensional molding technique for generating a three-dimensional molded matter of an object by means of a laser molding method, inkjet molding method, powder molding method and the like.

2. Description of the Background Art

Conventionally, as an apparatus for performing three-dimensional molding, apparatuses based on various kinds of molding methods such as laser molding method, inkjet molding method, powder molding method and the like have been known.

For example, a three-dimensional molding apparatus like a stereo laser apparatus based on the laser molding method sequentially reproduces the shape of an object to be molded by irradiating a liquid resin material which will harden by irradiation of predetermined light, with laser light. Such a three-dimensional molding apparatus is one of the most representative among three-dimensional molding apparatuses called a rapid prototyping apparatus.

Furthermore, a three-dimensional molding apparatus based on the inkjet molding method reproduces the shape of an object to be molded by sequentially overlaying ink while injecting a micro thermoplastic resin from a head provided with an inkjet nozzle.

Furthermore, in the powder molding method, an adhesive is discharged to a powder material which has been extended to a thin layer to allow the adhesive to be bound to the powder material, and formation of layer and discharge of the adhesive are repeated, whereby a three-dimensional molded matter is formed as a combined body of the powder material.

Furthermore, besides these methods, three-dimensional molding apparatuses based on a powder sintering method, paper laminating method and the like are known.

However, three-dimensional molded matters generated with the use of these prior art three-dimensional molding apparatuses have the same softness as a whole, so that, for example, as for an object to be molded of which softness differs depending on the part such as a bone part and a skin part in a human body model and the like, it was impossible to generate a three-dimensional molded matter faithfully reproducing the feel.

Furthermore, in order to faithfully reproduce the feel of the object to be molded in a three-dimensional molded matter, it is necessary to reproduce surface roughness and the like in addition to softness of each part. This is because softness reproduces surface elasticity of the three-dimensional molded matter, and the rough deposit feel of the surface of the three-dimensional molded matter can be faithfully reproduced only by surface roughness and the like.

### SUMMARY OF THE INVENTION

The present invention is directed to a three-dimensional molding apparatus.

According to one aspect of the invention, the three-dimensional molding apparatus comprises: an acquiring section for acquiring data for molding a three-dimensional object, the data including information regarding shape of the three-dimensional object and information regarding feel of each part of the three-dimensional object; a molding section for molding the three-dimensional object of a predetermined material; and a controller for controlling the molding section so as to mold the three-dimensional object reproducing the shape and the feel based on the data acquired by the acquiring section.

Therefore, it is possible to generate a three-dimensional molded matter faithfully reproducing feel of the three-dimensional object.

Furthermore, according to another aspect of the invention, the three-dimensional molding apparatus comprises: a molding section for generating the three-dimensional molded matter; a controller for controlling the molding section based on the shape data regarding shape of the object and the feel information regarding feel of the object.

Therefore, it is possible to generate a three-dimensional molded matter reproducing the shape and feel of the object.

Furthermore, according to a preferred embodiment of the three-dimensional molding apparatus in the present aspect, the feel information is information regarding softness of the object, and the controller forms a hollow portion having the size corresponding to the softness on the inner side of the three-dimensional molded matter.

Furthermore, according to another preferred embodiment of the three-dimensional molding apparatus in the present aspect, the feel information is information regarding softness of the object, and the three-dimensional molded matter is formed of a material having a quality corresponding to the softness.

Therefore, in these preferred embodiments, it is possible to generate a three-dimensional molded matter faithfully reproducing the feel relating to the softness of the object.

Furthermore, according to yet another preferred embodiment of the three-dimensional molding apparatus in the present aspect, the feel information is information regarding texture of the object, and the controller forms a micro projection of the size corresponding to the texture on the surface of the three-dimensional molded matter.

Furthermore, according to still yet another preferred embodiment of the three-dimensional molding apparatus in the present aspect, the feel information is information regarding texture of the object, and the three-dimensional molded matter is formed of a material having a quality corresponding to the texture.

Therefore, according to these preferred embodiments, it is possible to generate a three-dimensional molded matter faithfully reproducing the feel relating to the texture of the object.

The present invention is also directed to a data processing apparatus for generating molding data to be used in three-dimensional molding.

According to one aspect of the invention, the data processing apparatus comprises: a shape data inputting section for inputting shape data regarding shape of an object; a feel information acquiring section for acquiring feel information regarding feel of the object; and a data generating section for generating the molding data for reproducing shape and feel of the object based on the shape data and the feel information.

Therefore, it is possible to generate data capable of easily reproducing shape and feel of the object.

Furthermore, according to another aspect of the invention, the data processing apparatus comprises: a shape data inputting section for inputting shape data regarding shape of an object; a feel information acquiring section for acquiring feel information regarding feel of the object; and a memory for storing the shape data and the feel information in correlation with each other.

Therefore, it is possible to store the information for reproducing both the shape and the feel in the memory.

The present invention is also directed to a data processing method.

According to one aspect of the invention, the data processing method comprises the steps of: inputting shape data regarding shape of an object; inputting feel information regarding feel of the object; and storing the shape data and the feel information in correlation with each other.

Furthermore, according to another aspect of the invention, the data processing method comprises the steps of: inputting shape data regarding shape of an object; inputting feel information regarding feel of the object; and generating the molding data for reproducing shape and feel of the object based on the shape data and the feel information.

The present invention is also directed to a three-dimensional molding method for generating a three-dimensional molded matter of an object.

According to one aspect of the invention, the three-dimensional molding method comprises the steps of: inputting shape data regarding shape of the object and feel information regarding feel of the object; and generating the three-dimensional molded matter by controlling predetermined molding means based on the shape data and the feel information.

Furthermore, the present invention is also directed to molding data to be used in three-dimensional molding.

According to one aspect of the invention, the molding data comprises data structure in which shape data regarding shape of an object and feel information regarding feel of the object are correlated with each other.

Incidentally, “molding data” comprehends data signals for molding. Further, the molding data may be data recorded on a computer-readable medium.

As described above, it is an object of the invention to provide a three-dimensional molded matter faithfully reproducing feel of an object to be molded.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual drawing showing one configuration example of a three-dimensional molding system;

FIG. 2 is a conceptual drawing showing STL data;

FIG. 3 is a conceptual drawing for measuring elasticity;

FIG. 4 is a conceptual drawing of STL data in which shape and feel are correlated with each other;

FIG. 5 is a conceptual drawing showing a configuration example of a three-dimensional molding system;

FIG. 6 is a view showing a laser molding apparatus which is a three-dimensional molding apparatus based on the laser molding method;

FIG. 7 is a flow chart showing a processing sequence of laser molding for reproducing elasticity;

FIG. 8 is a view showing the relationship between spring constant and diameter of a micro hole;

FIGS. 9A and 9B are views conceptually showing addition of shape of a micro hole;

FIG. 10 is a view showing an example of ON/OFF control of a light source by a controller;

FIG. 11 is a flow chart showing a processing sequence of laser molding for reproducing texture;

FIG. 12 is a view showing the relationship between texture information and diameter of a micro projection;

FIGS. 13A and 13B are views conceptually showing addition of shape of a micro projection;

FIGS. 14A and 14B are views conceptually showing addition of shape of a micro projection;

FIG. 15 is a view showing an example of ON/OFF control of a light source by a controller;

FIG. 16 shows an inkjet molding apparatus which is a three-dimensional molding apparatus based on the inkjet molding method;

FIG. 17 is a flow chart showing a processing sequence of inkjet molding for reproducing elasticity;

FIG. 18 is a view showing the relationship between composition ratio of a certain resin material and spring constant;

FIG. 19 is a view showing an inkjet molding apparatus which is a three-dimensional molding apparatus based on the inkjet molding method;

FIG. 20 is a flow chart showing a processing sequence of inkjet molding for reproducing texture;

FIG. 21 is a view showing a powder molding apparatus which is a three-dimensional molding apparatus based on the powder molding method;

FIG. 22 is a view showing a configuration in which powder materials are mixed for the purpose of realizing arbitrary elasticity;

FIG. 23 is a flow chart showing a processing sequence of powder molding for reproducing elasticity;

FIG. 24 is a flow chart showing a processing sequence of power molding for reproducing texture;

FIG. 25 is a view showing a powder molding apparatus which is a three-dimensional molding apparatus based on the powder molding method;

FIG. 26 is a flow chart showing a processing sequence of powder molding for reproducing elasticity;

FIG. 27 is a flow chart showing a processing sequence of powder molding for reproducing texture; and

FIGS. 28A to 28C are views schematically showing other powder molding operations

### DESCRIPTION OF THE PREFERRED EMBODIMENTS

In the following, detailed description on preferred embodiments of the present invention will be made with reference to the drawings.

<1. General Configuration of Three-dimensional Molding System and Generation of Molding Data>

First, a general configuration of a three-dimensional molding system according to the present preferred embodiment will be explained.

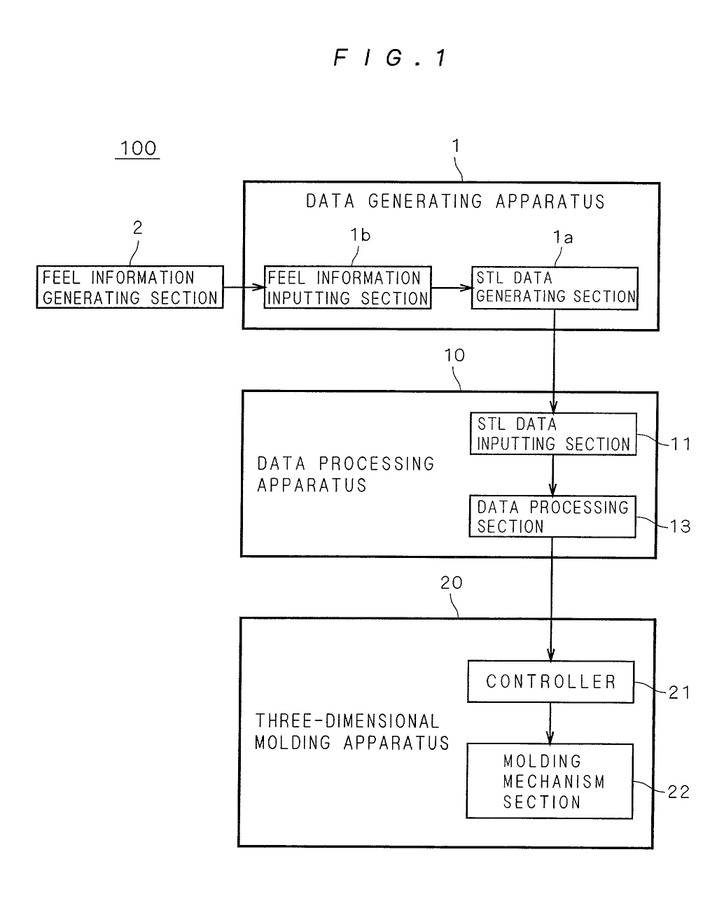

FIG. 1 is a conceptual drawing showing one configuration example of a three-dimensional molding system 100. This three-dimensional molding system 100 comprises a data generating apparatus 1, a feel information generating section 2, a data processing apparatus 10 and a three-dimensional molding apparatus 20.

The data generating apparatus 1 includes an STL (Stereo Lithography) data generating section 1a and a feel information inputting section 1b.

The STL data generating section 1a is configured by a three-dimensional CAD apparatus called a three-dimensional solid modeler or three-dimensional surface modeler, an apparatus for directly measuring shape of an object to be molded and the like, and is configured so as to express the three-dimensional shape of the object to be molded by means of a data structure of STL format which has developed to a field standard in the technical field of rapid prototyping and to output the STL data generated as a result of this.

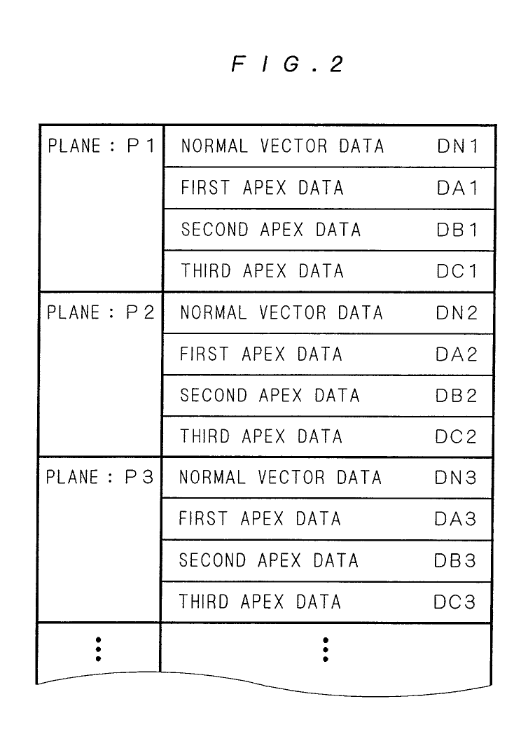

FIG. 2 is a conceptual drawing showing STL data generated in the STL data generating section 1a. The STL data forms shape data representing the shape of the object to be molded by approximating the surface of the object to be molded as an assembly of micro triangular planes. As shown in FIG. 2, the STL data has normal vector data DN1, first apex data DA1, second apex data DB1 and third apex data DC1 for a micro plane P1. The same applies also to other micro planes P2, P3, . . . That is, each micro plane is defined by three apexes constituting the micro triangle and the normal for representing inward direction of the spatial object.

Then, as the information other than the shape, feel information is added to the STL data which is shape data of the object to be molded generated in the STL data generating section 1a.

The feel information generating section 2 generates feel information of an object to be molded by measuring feel of surface of the object to be molded. The feel includes elasticity, touch feel and the like of surface of the object to be molded.

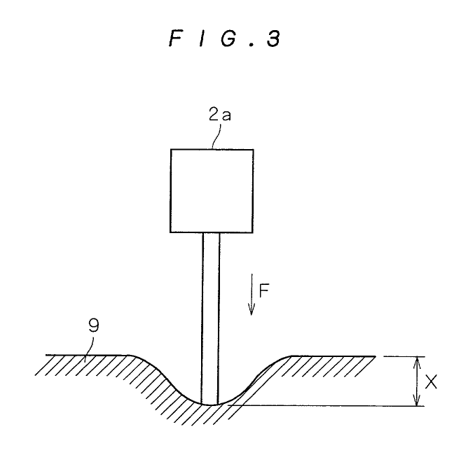

FIG. 3 is a conceptual drawing for measuring elasticity. The feel information generating section 2 applies power F to a certain point on a surface 9 of the object to be molded from a displacement sensor 2a. Then a displacement amount X of the surface 9 of the object to be molded is detected. A spring constant K at this time can be determined by calculation of K=F/X. This spring constant K is to be information representing elasticity at the measured point of the object to be molded. Then, the feel information generating section 2 calculates the spring constant K for a plurality of points of the object to be molded in the above-mentioned manner and outputs the constants to the data generating apparatus 1.

Furthermore, the feel information generating section 2 measures surface roughness at a certain point of the object to be molded and generates information regarding the surface roughness as texture information. Accordingly, the texture information is information for reproducing touch feel and the like of the object to be molded. For example, it is possible to generate texture information based on center line average height used as an index of surface roughness, the size of a particle of the material forming the object to be molded and the like. Then, the feel information generating section 2 generates texture information for a plurality of points of the object to molded and outputs the resultant information to the data generating apparatus 1.

In other words, the feel information generating section 2 outputs the spring constant relating to the elasticity, the texture information regarding the surface roughness and the like to the data generating apparatus 1 as feel information.

While the above description was made for the case where the feel information generating section 2 generates feel information by measuring spring constant, surface roughness and the like at a certain point of the object to be molded, it is also possible to configure the feel information generating section 2 by a general computer for allowing a user to input feel information of each part of the object to be molded by manual input in the case where it is impossible to measure the object to be molded, for example, in the case where the object to be molded does not actually exist.

Furthermore, in addition to the information regarding elasticity, touch feel and the like, the feel information generating section 2 may include other information in the feel information.

Then, in the data generating apparatus 1, the feel information inputting section 1b acquires feel information from the feel information generating section 2 and supplies the acquired feel information to the STL data generating section 1a.

Them, the STL data generating section 1a adds the feel information acquired from the feel information generating section 2 to STL data which is the data regarding shape of the object to be molded.

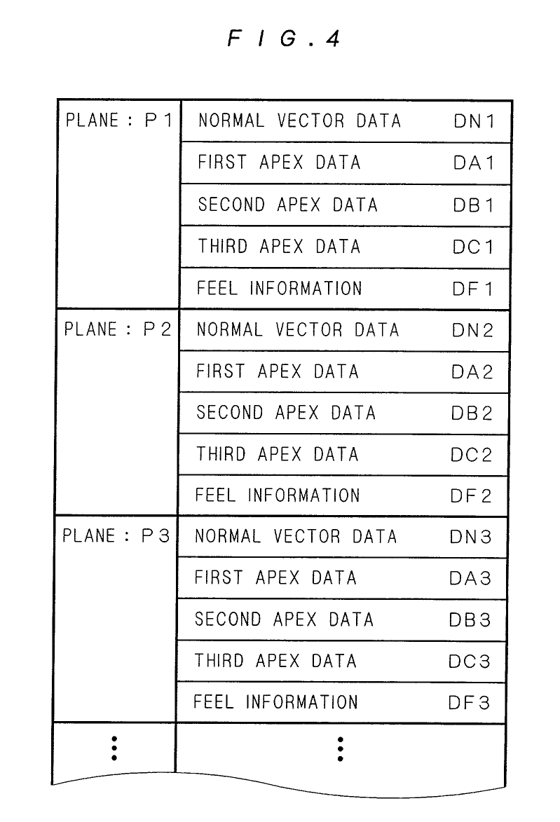

FIG. 4 is a conceptual drawing of STL data generated in the STL data generating section 1a. As shown in FIG. 4, the STL data generating section 1a generates molding data by adding feel information DF1, DF2, . . . for each micro plane of the STL data. In this connection, the feel information DF1, DF2, . . . to be added is feel information obtained from the feel information generating section 2.

Since the feel information generating section 2 determines the feel information not for all the surface of the object to be molded but for plural representative points, not all the micro planes have corresponding feel information. For this reason, in the case where feel information corresponding to a certain micro plane is not acquired, the STL data generating section 1a generates feel information corresponding to each micro plane by performing interpolation using neighboring feel information and correlating the generated feel information with the respective micro plane, thereby correlating the shape and the feel as shown in FIG. 4.

Furthermore, it is also possible that the STL data generating section 1a has a function of determining a suitable material for reproducing such a feel based on feel information, and a suitable material for reproducing feel of each micro plane is contained in each feel information DF1, DF2, . . .

Incidentally, there would be the case that when plural kinds of parameters are contained in feel information, such as when spring constant and texture information are contained in the feel information, it is difficult to reproduce feel of a three-dimensional molded matter based on all of such parameters. In such a case, it is preferred that priorities that indicate which parameter takes priority in reproducing feel are correlated to each of the parameters. As a result of this, it is possible to reproduce feel of higher priority in the case where it is difficult to faithfully reproduce both the spring constant and the texture, for example.

The STL data generating section 1a generates STL data in this manner, and outputs the STL data to the data processing apparatus 10. Of course, also in the STL data generating section 1a, the feel information DF1, . . . corresponding to the respective micro planes may be inputted and set by manual input and the like by a user.

The data processing apparatus 10 acquires STL data by an STL data inputting section 11 and supplies a data processing section 13 with the acquired STL data. Then, the data processing section 13 generates molding data for reproducing shape and feel of the object to be molded based on the STL data. Then, the generated molding data is supplied to the three-dimensional molding apparatus 20.

The three-dimensional molding apparatus 20 generates a three-dimensional molded matter which is a prototype of the object to be molded by using a predetermined material, and includes a controller 21 and a molding mechanism section 22. The controller 21 drives and controls the molding mechanism section 22 based on the molding data acquired from the data processing apparatus 10. The molding mechanism section 22 generates a three-dimensional molded matter by the control from the controlling 21 using a predetermined material. The molding mechanism section 22 may be based on any of the laser molding method, the inkjet molding method and the powder molding method. Furthermore, the three-dimensional molding may be based on other molding methods than the laser molding method, the inkjet molding method and the powder molding method.

The three-dimensional molding apparatus 20 is so configured as to perform molding operation of a three-dimensional molded matter based on the molding data acquired from the data processing apparatus 10. In the molding operation, since molding operation is made on the basis of feel information corresponding to each micro planes is performed, it is possible to realize feel of the three-dimensional molded matter in the same condition as the feel of the object to be molded.

In the above description, explanation was mode for the example where the data processing apparatus 10 and the three-dimensional molding apparatus 20 are separately configured, however it is also possible to configure the data processing apparatus 10 as an internal facility of the three-dimensional molding apparatus 20.

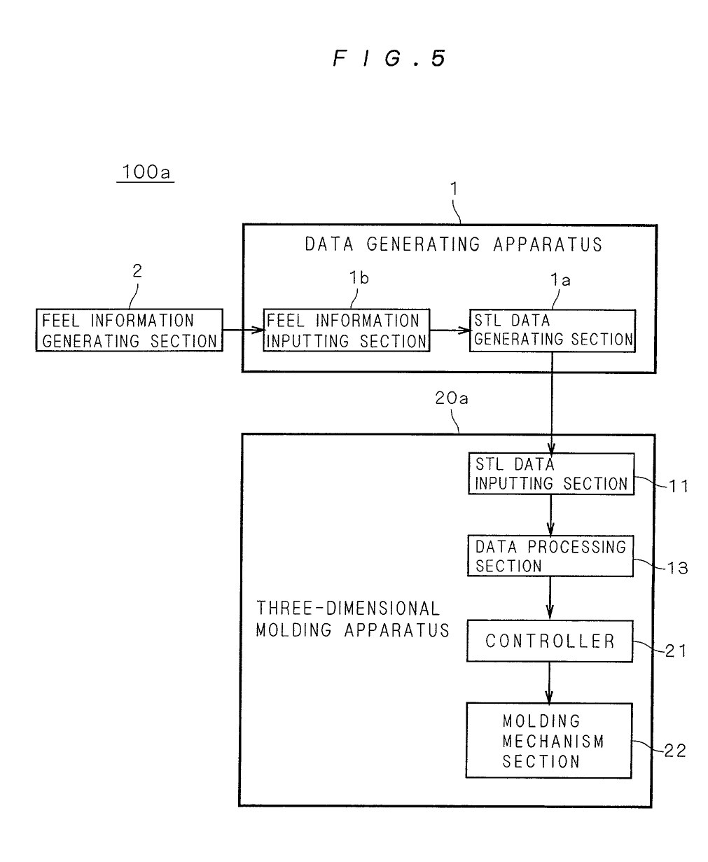

FIG. 5 is a conceptual drawing showing a configuration example of a three-dimensional molding system 100a having such a configuration. As shown in FIG. 5, in the three-dimensional molding system 100a, a three-dimensional molding apparatus 20a comprises the STL data inputting section 11, the feel information inputting section 12, the data processing section 13, the controller 21 and the molding mechanism section 22, and the three-dimensional molding apparatus 20a realizes the function of the above-mentioned data processing apparatus 10. Also in this configuration, detail functions and activities of the respective parts are as same as those described above.

Also, it goes without saying that molding data generated in the data processing apparatus 10 may be in the state of being recorded on a transportable recording medium such as memory card or CD-R and may be inputted to the three-dimensional molding apparatus 20.

<2. Laser Molding Method>

First, explanation will be made on the case where the molding method in the molding mechanism section 22 is the laser molding method.

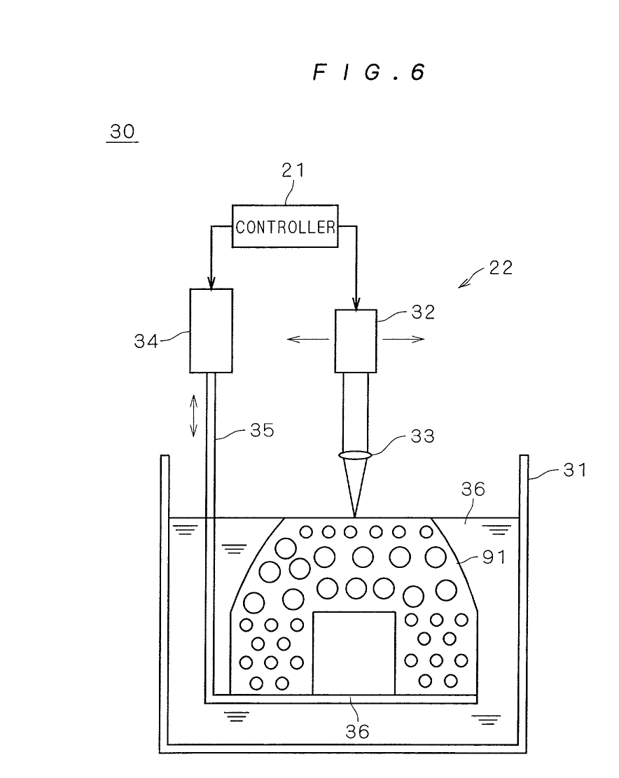

FIG. 6 is a view showing a laser molding apparatus 30 which is so called a stereo laser apparatus and operable as a three-dimensional molding apparatus based on the laser molding method. The laser molding apparatus 30 includes as the molding mechanism section 22, a resin tank 31 for storing a liquid photo-curable resin, a stage 36 for generating a three-dimensional molded matter, a supporting member 35 for supporting the stage 36, an elevator driving section 34 for moving up or down the supporting member 35 and the stage 36 at micro pitches, a light source 32 for generating laser light for curing the photo-curable resin, and a condenser lens 33 for causing the laser light from the light source 32 to be condensed on the liquid surface of the photo-curable resin. The controller 21 moves the head portion consisting of the light source 32 and the condenser lens 33 in any positions within the XY plane while controlling the elevator driving section 34 and the light source 32.

In performing three-dimensional molding by using this laser molding apparatus 30, first, the top surface of the stage 36 is initially set at a position slightly lower than the liquid surface, and under this condition, the head portion is controlled to scan the XY plane and the light source 32 is ON/OFF controlled based on the molding data. As a result of this, a shape of one layer of the three-dimensional molded matter having a micro thickness is realized on the stage 36. Then, the stage 36 is moved down by a distance corresponding to the thickness of one layer, and the photo-curable resin is cured thereon for forming the next one layer. By repeating such operations, a three-dimensional molded matter 91 is sequentially formed on the stage 36 by the cured resin in the resin tank 31, and finally a complete product of the three-dimensional molded matter 91 is obtained on the stage 36.

In molding the three-dimensional molded matter 91, the three-dimensional molded matter 91 is molded to have the same feel as the object to be molded based on the feel information of the molding data.

To be more specific, in order to reproduce elasticity such as softness and the like of the object to be molded, a hollow portion (micro hole) is formed on the inner side of the three-dimensional molded matter 91 so that the shrinkage amount at the time of application of pressure onto the surface of the three-dimensional molded matter 91 is approximately equal to the displacement amount determined by the spring constant K. Since there is a case that the spring constant K differs depending on the part of the three-dimensional molded matter 91, in such a case, the diameter of hollow portion to be formed on the inner side is varied depending on the part to realize that each part represents the shrinkage amount based on the respective spring constant K.

Furthermore, in order to realize smoothness of touch feel such as rough feel and smooth feel of the object to be molded, a micro projection in accordance with the texture information is formed on the surface of the three-dimensional molded matter 91. Since the texture information is the information regarding surface roughness of the object to be molded, by changing the shape, size and the like of the micro projection based on the texture information, it is possible to realize touch feel of the surface of the three-dimensional molded matter 91 as same as that of the object to be molded. Furthermore, since there is a case that the texture information differs depending on the part of the three-dimensional molded matter 91, in such a case, by changing the shape, size and the like of the micro projection to be formed on the surface depending on the part, it is possible to realize the touch feel for each part in accordance with the texture information.

In the following, a concrete processing sequence for realizing these feels will be explained.

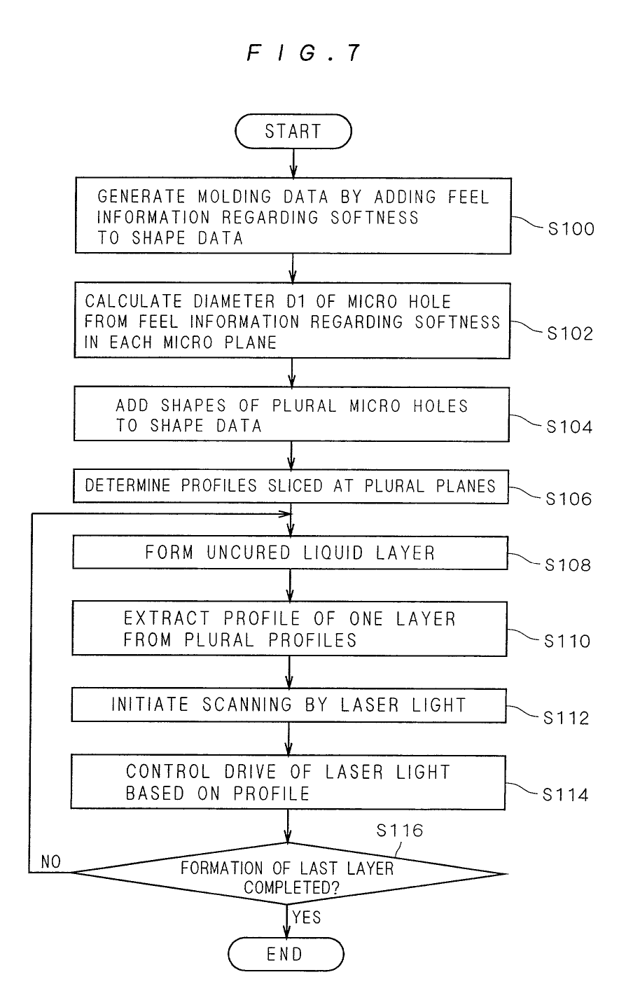

FIG. 7 is a flow chart showing a processing sequence of laser molding for reproducing elasticity of the three-dimensional molded matter in the three-dimensional molding system 100.

First, the data generating apparatus 1 adds feel information (spring constant K) regarding softness or elasticity of the object to be molded to the STL data which is shape data, and the data processing apparatus 10 generates molding data. Then, the molding data is supplied to the controller 21 of the laser molding apparatus 30 (step S100). Then, the controller 21 of the laser molding apparatus 30 determines a diameter D1 of a hollow portion or a micro hole to be formed on the inner side when molding a part corresponding to a micro plane from feel information regarding the elasticity of the micro plane defined in the molding data by performing a predetermined operational processing (step S102).

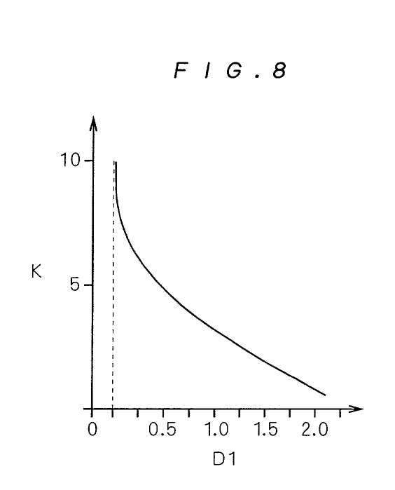

FIG. 8 is a view showing the relationship between spring constant K and diameter D1 of a micro hole. As shown in FIG. 8, when the spring constant K is large, the diameter D1 of the micro hole to be formed on the inner side of the three-dimensional molded matter is small, while on the other hand, when the spring constant K is small, the diameter D1 of the micro hole is large. The controller 21 performs calculation based on a predetermined operation formula representing the relationship as shown in FIG. 8 to determine the diameter D1 of the micro hole from the spring constant K. Of course, the relationship between spring constant K and diameter D1 of a micro hole as shown in FIG. 8 may be stored in an internal memory and the like of the controller 21, for example, and the controller 21 may search the internal memory and the like based on the feel information described in the molding data to determine the diameter D1.

Then, the controller 21 adds the shape of the micro hole determined in step S102 to the shape data of the molding data (step S104). For example, since the shape data contained in the molding data is shape data regarding the outer shape of the object to be molded, generally no data regarding the inner shape is contained. However, since it is necessary to form a micro hole on the inner side in performing molding according to the present preferred embodiment, the shape of the micro hole is added to the shape data.

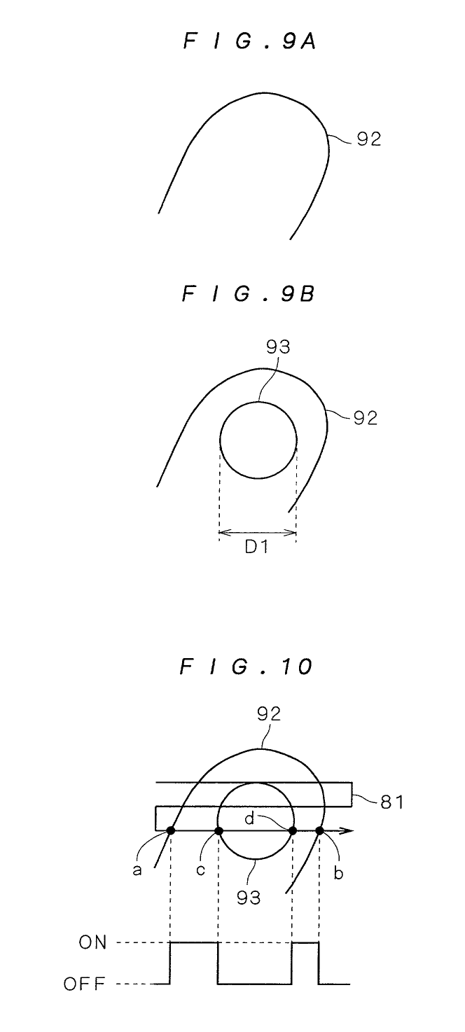

FIGS. 9A and 9B are views conceptually showing addition of shape of the micro hole. When an outer shape 92 for molding the three-dimensional molded matter is the shape as shown in FIG. 9A, the controller 21 adds (transforms) the shape of a micro hole 93 of a diameter D1 on the inner side of the outer shape 92 to generate shape data for realizing elasticity of the feel information (FIG. 9B). As a result of this, the spatial shape data contained in the molding data includes not only the shape for reproducing outer shape of the object to be molded but also the shape for reproducing elasticity which is the feel of the object to be molded. In addition, when the feel information differs depending on the part, the shape data is generated so that the micro hole 93 varying depending on the part is formed on the inner side of the molded matter.

Then, on the basis of the spatial shape data to which the shape of the micro hole 93 is added in step S104, the controller 21 determines profiles which are sliced at a plurality of planes at micro pitches by which the stage 36 is sequentially moved down at the time of laser molding (step S106). This profile is used as shape data in performing molding operation for one layer by causing the head portion including the light source 32 to scan the XY plane when the stage 36 is at a certain level.

Then, the controller 21 drives the elevator driving section 34 to cause an uncured liquid layer on the top surface side of the stage 36 or on the upper end side of the three-dimensional molded matter 91 (step S108). Then, the controller 21 extracts a profile of one layer which is an object to be molded from the plurality of profiles (step S110), and initiate scanning by laser light according to the extracted profile (step S112). Then, for realizing the shape of one layer corresponding to the profile, the controller 21 performs ON/OFF control of the light source 32 according to the profile to cure the photo-curable resin (step S114).

FIG. 10 is a view showing an example of ON/OFF control of the light source 32 by the controller 21. As shown in FIG. 10, the laser light from the light source 32 scans while passing through a route 81 by the control of the controller 21. The controller 21 switches ON/OFF condition of the laser light at each of positions a, b, c, d so as to reproduce the outer shape 92 for molding the three-dimensional molded matter and the micro hole 93 on the inner side of the three-dimensional molded matter. To be more specific, the laser light is switched to ON condition at the position a to cause the resin to be cured, thereby reproducing the outer shape 92 of the three-dimensional molded matter, and the laser light is switched to OFF condition at the position c, thereby forming the micro hole 93 on the inner side of the three-dimensional molded matter. Furthermore, the laser light is switched to ON condition at the position d to cause the resin to be cured for generating the three-dimensional molded matter, and the laser light is switched to OFF condition at the position b to reproduce the outer shape 92 of the three-dimensional molded matter. By switching ON/OFF condition at the outer shape portion and the micro hole portion of the profile as described above, it is possible to reproduce a three-dimensional molded matter having the same elasticity as the object to be molded.

Then, the controller 21 judges whether or not formation of the last layer has completed (step S116), and if it is judged “YES” which means that a desired three-dimensional molded matter has completed on the stage 36, the controller 21 terminates the processing, and if it is judged “NO”, the processing of steps S108 to S114 is repeated until formation of the last layer completes.

The three-dimensional molded matter 91 obtained by the processing as described above has not only the shape as same as the outer shape of the object to be molded but also the elasticity as same as that of the object to be molded by means of the micro holes formed on the inner side of the molded matter. That is, the three-dimensional molded matter is configured to have a plurality of micro holes on the inner side thereof in a sponge-like state, and adjustment is made so that the elasticity of the three-dimensional molded matter corresponds to that of the object to be molded by means of these micro holes. Furthermore, in the case where the elasticity of the object to be molded differs depending on the part, the micro hole formed in the part corresponding to such part on the inner side of the three-dimensional molded matter 91 has different size, so that also the elasticity of the three-dimensional molded matter 91 is realized to be different depending on the part similarly to the object to be molded.

Therefore, by applying the above-described processing sequence to the laser molding method, it is possible to reproduce the elasticity of the three-dimensional molded matter in the condition similar to that of the object to be molded.

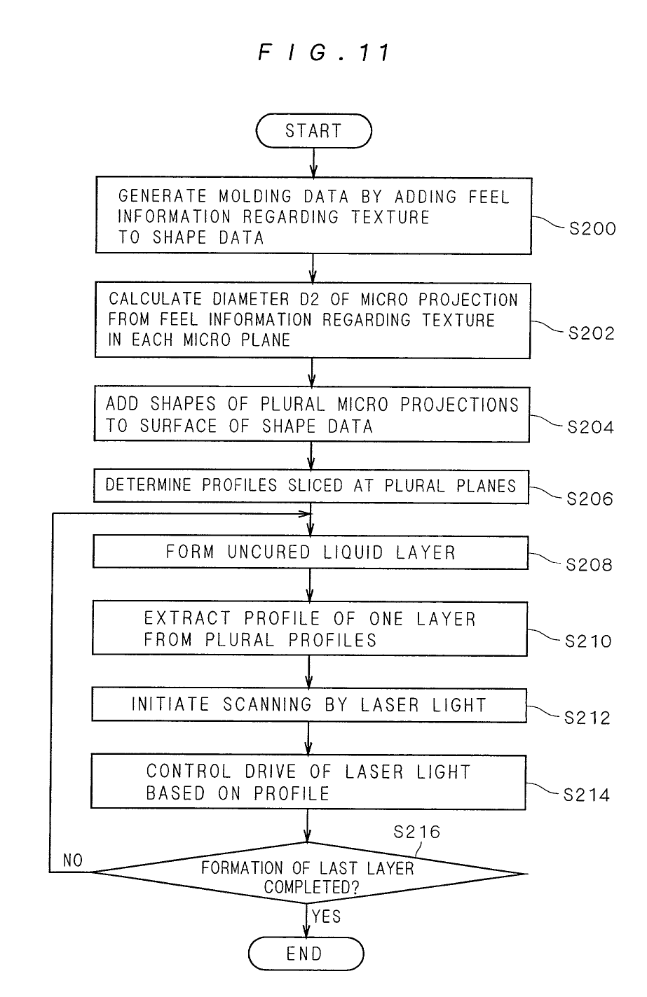

Next, FIG. 11 is a flow chart showing a processing sequence of laser molding for reproducing texture of a three-dimensional molded matter in the three-dimensional molding system 100.

First, the data generating apparatus 1 adds feel information regarding touch feel, i.e., texture of the object to be molded (texture information) to the STL data which is shape data, and the data processing apparatus 10 generates molding data. Then, the molding data is supplied to the controller 21 of the laser molding apparatus 30 (step S200). Then, in molding a part corresponding to each micro plane based on the feel information regarding the texture (texture information) of the micro plane defined in the molding data, the controller 21 of the laser molding apparatus 30 determines the size of the micro projection to be formed in the part (more specifically, diameter D2) by performing a predetermined operational processing (step S202).

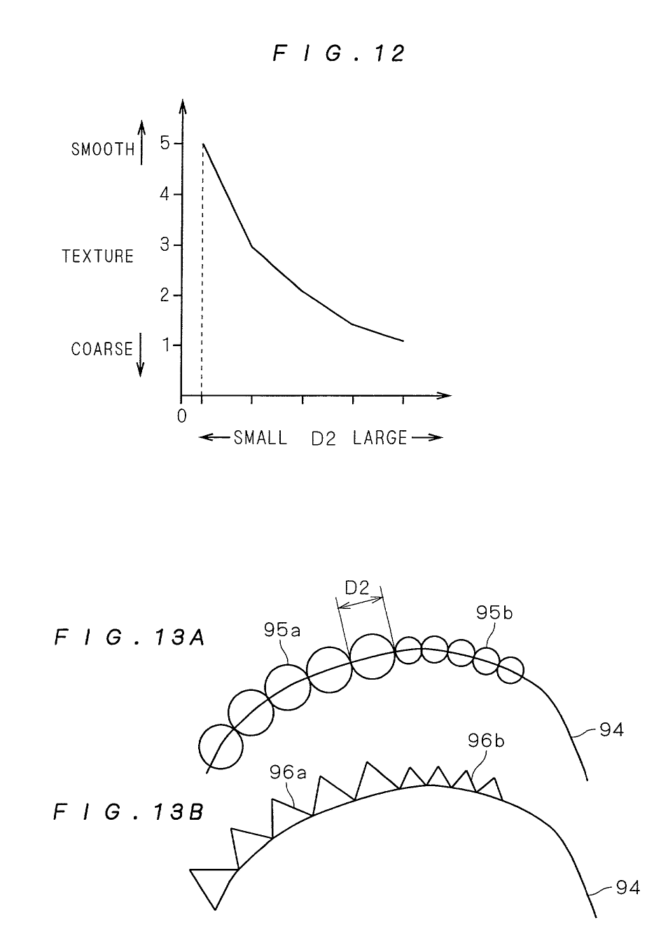

FIG. 12 is a view showing the relationship between texture information and diameter D2 of micro projection. This graph means that when the texture information is large, the surface roughness of that part is smooth, while on the other hand, when the texture information is small, the surface roughness of that part is rough. Therefore, as shown in FIG. 12, when the value of the texture information is large, the size of the micro projection to be formed on the surface of the three-dimensional molded matter is small, while on the other hand, when the value of the texture information is small, the size of the projection to be formed on the surface of the three-dimensional molded matter is large. The controller 21 determines the diameter D2 of the micro projection from the value of the texture information by performing calculation based on a predetermined operation formula representing the relationship as shown in FIG. 12. Of course, the relationship between texture information and diameter D2 of micro projection as shown in FIG. 12 may be stored in an internal memory and the like of the controller 21, for example, and the controller 21 may search the internal memory and the like based on the feel information described in the molding data to determine the diameter D2.

Then, the controller 21 adds the shape of the micro projection determined in step S202 to the shape data of the molding data (step S204). Since the shape data contained in the molding data is shape data regarding the outer shape of the object to be molded excluding the micro projection and the like, the shape of the micro projection is added to the shape data regarding the outer shape.

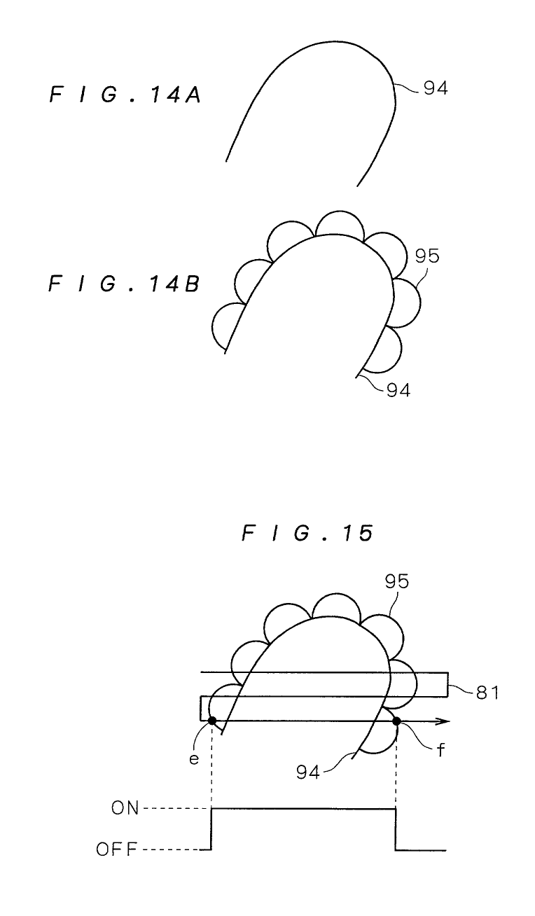

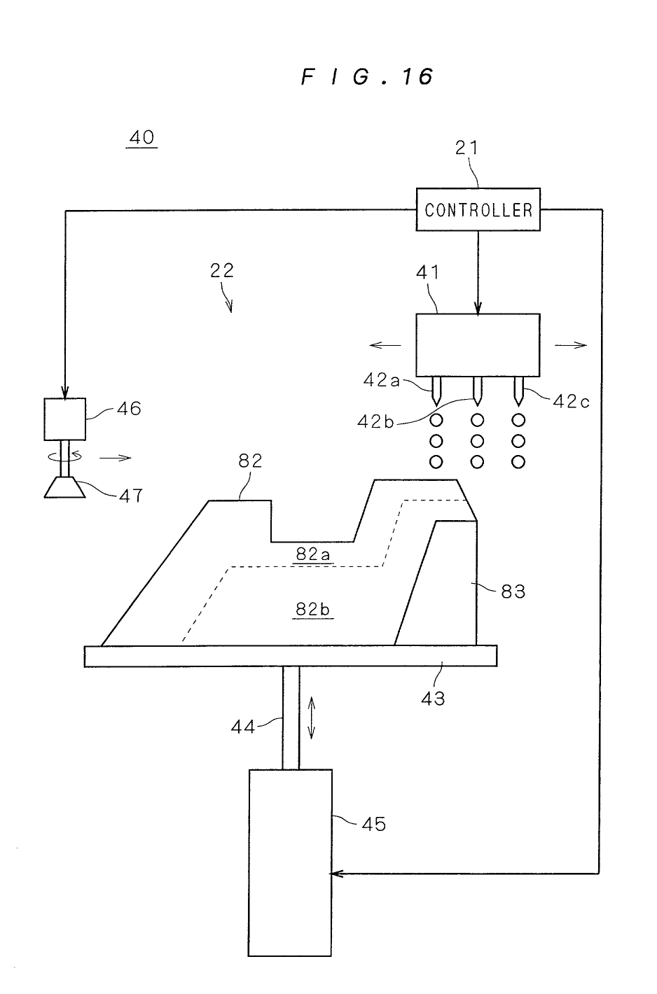

FIGS. 13A and 13B, and FIGS. 14A and 14B are views conceptually showing addition of the shape of the micro projection. As shown in FIG. 13A, in the case where there is an outer shape 94 for reproducing the shape of the original object to be molded, the controller 21 adds (transforms) the shape of a micro projection 95a, 95b of a semispherical shape corresponding to the texture information. The size of the micro projection 95a, 95b corresponds to the diameter D2 determined as described above. Difference in size between the micro projection 95a and the micro projection 95b as shown in FIG. 13A is caused by that the values of texture information corresponding to these parts differ from each other.

Furthermore, it is also possible to form a micro projection 96a, 96b of a cone shape as shown in FIG. 13B. If cones as shown in FIG. 13B are formed, it is possible to make the touch feel of the surface of the three-dimensional molded matter closer to that of the object to be molded.

While FIG. 12 shows the relationship between texture information and size of a micro projection, it is also possible to configure that the shape of the micro projection to be formed on the surface of the three-dimensional molded matter to be changed in accordance with the value of the texture information. For example, in the case where the value of the texture information is large so that it is intended to finish the surface of the three-dimensional molded matter relatively smooth, spheres not having corners as shown in FIG. 13A are formed as the micro projections. To the contrary, in the case where the value of the texture information is small so that it is intended to finish the surface of the three-dimensional molded matter relatively rough, the cones having corners shown in FIG. 13B are formed as the micro projections, making it is possible to faithfully reproduce the touch feel and the like of the object to be molded in the three-dimensional molded matter.

Then, in the case where there is the original outer shape 94 as shown in FIG. 14A, the controller 21 adds (transforms) the shape of the micro hole 95 of a diameter D2 on the surface of the outer shape 94 to generate shape data for realizing texture of the feel information (FIG. 14B). As a result of this, the spatial shape data contained in the molding data includes not only the shape for reproducing the outer shape of the object to be molded but also the shape for reproducing the texture, i.e., touch feel of the object to be molded. Furthermore, when the feel information differs depending on the part, the shape data is generated so that the micro hole 95 varying depending on the part is formed on the surface.

Then, on the basis of the spatial shape data to which the shape of the micro projection 95 is added in step S204, the controller 21 determines profiles which are sliced at a plurality of planes at micro pitches by which the stage 36 is sequentially moved down at the time of laser molding (step S206). This profile is used as shape data in performing molding operation for one layer by causing the head portion including the light source 32 to scan the XY plane when the stage 36 is at a certain level.

Then, the controller 21 drives the elevator driving section 34 to cause an uncured liquid layer on the top surface side of the stage 36 or on the upper end side of the three-dimensional molded matter 91 (step S208). Then, the controller 21 extracts a profile of one layer which is an object to be molded from the plurality of profiles (step S210), and initiates scanning by laser light based on the extracted profile (step S212). Then, for realizing the shape of one layer corresponding to the profile, the controller 21 performs ON/OFF control of the light source 32 based on the profile to cause the photo-curable resin to be cured (step S214).

FIG. 15 is a view showing an example of ON/OFF control of the light source 32 by the controller 21. As shown in FIG. 15, the laser light from the light source 32 scans so as to pass through the route 81 by the control of the controller 21. The controller 21 switches ON/OFF condition of the laser light at each of positions e, f so as to reproduce the outer shape 94 for molding the three-dimensional molded matter and the micro projection 95 on the inner side of the three-dimensional molded matter, respectively. To be more specific, the laser light is switched to ON condition at the position e to initiate curing of the resin, and the laser light is switched to OFF condition at the position f. As a result of this, not only the outer shape of the three-dimensional molded matter can be formed similarly to the outer shape of the object to the object to be molded, but also it becomes possible to reproduce the touch feel and the like of the surface of the three-dimensional molded matter as same as that of the object to be molded.

Then, the controller 21 judges whether or not formation of the last layer has completed (step 216), and if it is judged “YES” which means that a desired three-dimensional molded matter has completed on the stage 36, the controller 21 terminates the processing, and if it is judged “NO”, the processing of steps S208 to S214 is repeated until formation of the last layer completes.

The three-dimensional molded matter 91 (see FIG. 6) obtained by the processing as described above has not only the shape as same as the outer shape of the object to be molded but also the touch feel as same as that of the object to be molded by means of the micro projections formed on the surface of the molded matter. Furthermore, in the case where the touch feel of the object to be molded differs depending on the part, the micro projection formed in the part corresponding to such a part on the surface of the three-dimensional molded matter 91 has the different size, so that also the touch feel of the three-dimensional molded matter 91 is realized to be different depending on the part similarly to the object to be molded.

Therefore, by applying the above-described processing sequence to the laser molding method, it is possible to reproduce the texture, i.e., touch feel of the three-dimensional molded matter in the condition similar to that of the object to be molded.

In the above description, explanation was made while separating the case where elasticity of the object to be molded is reproduced and the case where texture the same is reproduced, however, it is also possible to reproduce them at the same time. In such a case, in addition to determining the shape of the micro hole to be formed on the inner side of the molded matter (diameter D1) from the spring constant K, the shape of the micro projection to be formed on the surface side (diameter D2) from the texture information, and such shape data are added to the shape data of the molding data. Then, by determining a profile from the spatial shape data to which such shapes have been added, and performing sequential molding operation, it is possible to make both the elasticity and the touch feel of the three-dimensional molded matter correspondence with those of the object to be molded.

<3. Inkjet Molding Method>

Next, explanation of three-dimensional molding will be made for the case where the molding method in the molding mechanism section 22 is the inkjet molding method.

FIG. 16 is a view showing an inkjet molding apparatus 40 which is a three-dimensional molding apparatus based on the inkjet molding method. The inkjet molding apparatus 40 comprises as the molding mechanism section 22 shown in FIG. 1 or FIG. 5, an inkjet head 41 storing a plural kinds of liquid resins like wax which are heat-molten thermoplastic resins, and discharging the resins in the form of droplet; a stage 43 which is a base on which liquid resins discharged from the inkjet head 41 are accumulated for generating a three-dimensional molded matter 82; a supporting member 44 for supporting the stage 43; an elevator driving section 45 for enabling elevator operation of the stage 43 by moving up or down the supporting member 44; a milling cutter 47 for adjusting height dimension of the resin to be overlaid on the stage 43; and a driving section 46 for rotating the milling cutter 47 and moving the milling cutter 47 in the XY plane. The driving section 45 is controlled by the controller 21, so that the stage 43 can be positioned at arbitrary height. Also the operation of the milling cutter 47 is controlled by the controller 21.

The inkjet head 41 is provided with a plurality of nozzles 42a, 42b, 42c, and under the control of the controller 21, liquid resins of different kinds are discharged from the respective nozzles 42a, 42b, 42c. Furthermore, the inkjet head 41 is configured to move within the XY plane under the control of the controller 21, and hence each nozzle 42a, 42b, 42c can be moved to arbitrary position on the stage 43.

The nozzle 42a and the nozzle 42b discharge resins for molding the three-dimensional molded matter 82, and the nozzle 42c discharges a resin for forming a support portion 83 for supporting an overhung portion if the three-dimensional molded matter 82 has the overhung portion.

In performing three-dimensional molding by using this inkjet molding apparatus 40, first, the top surface of the stage 43 is initially set at a position slightly lower than the resin discharging position of each nozzle 42a, 42b, 42c, and under this condition, the inkjet head 41 is controlled to scan the XY plane and each nozzle is controlled to discharge a predetermined resin according to the molding data. As a result of this, a shape of one layer of the three-dimensional molded matter having a micro thickness is realized on the stage 43. Then, the stage 43 is moved down by a distance corresponding to the thickness of one layer, and a resin is discharged thereon so as to form the next one layer. By repeating such operations, the resin discharged on the stage 43 cures to sequentially form the three-dimensional molded matter 82, and finally a complete product of the three-dimensional molded matter 82 is obtained on the stage 43.

Incidentally, in the overhung portion, the support portion 83 is formed by the resin discharged from the nozzle 42c, and a molding resin is discharged thereon to thereby reproduce a suitable overhung shape. As the resin for forming the support portion 83, resins having lower melting point than that of the resin for molding the three-dimensional molded matter 82 are used, and making the temperature after completion of the molding lower than the melting point of the molding resin and higher than the melting point of the resin for support, it is possible to remove only the support portion 83 from the three-dimensional molded matter 82.

Accordingly, in the present preferred embodiment, in molding the three-dimensional molded matter 82, the molding is performed so that the feel of the three-dimensional molded matter 82 is as same as that of the object to be molded based on the feel information of the molding data.

For example, in the case of reproducing elasticity such as softness of the object to be molded, the nozzle 42a discharges a resin having a property that becomes relatively soft when cured, and the nozzle 42b discharges a resin of having a property that becomes relatively hard when cured. Then, based on the information regarding the softness which is the feel information correlated to each micro plane of the molding data (spring constant K), the resin material which corresponds or similar to that elasticity is determined, and either one nozzle is selected from the nozzles 42a, 42b. Then, in performing molding operation of that part, by causing the selected nozzle to discharge the resin, it is possible to generate the three-dimensional molded matter 82 having elasticity similar to the elasticity indicated by the feel information. In the example shown in FIG. 16, assuming that an upper part 82a of the three-dimensional molded matter 82 is formed of the resin discharged from the nozzle 42a, and a lower part 82b is formed of the resin discharged from the nozzle 42b, the upper part 82a of the three-dimensional molded matter 82 will be generated in a relatively soft condition, while the lower part 82b of the three-dimensional molded matter 82 will be generated in a relatively hard condition.

In FIG. 16, explanation was made for the example where two resins are discharged from two nozzles 42a, 42b so as to reproduce feel of the object to be molded, however, by setting the number of kinds of resin 3 or more, and the number of nozzles 3 or more, thereby performing the molding by selecting a resin material having closest softness and the like, it is possible to reproduce the feel of the object to be molded more faithfully.

Furthermore, in the case where an arbitrary elasticity is reproduced in the three-dimensional molded matter 82 by using two kinds of resins having different elasticities, if it is so configured that the controller 21 determines the composition ratio of these two kinds of resins based on the spring constant K of the feel information, and molding is performed while discharging the resin materials according to the composition ratio, it is possible to generate a three-dimensional molded matter having an elasticity which is in the middle of the elasticities exhibited by the two kinds of resins.

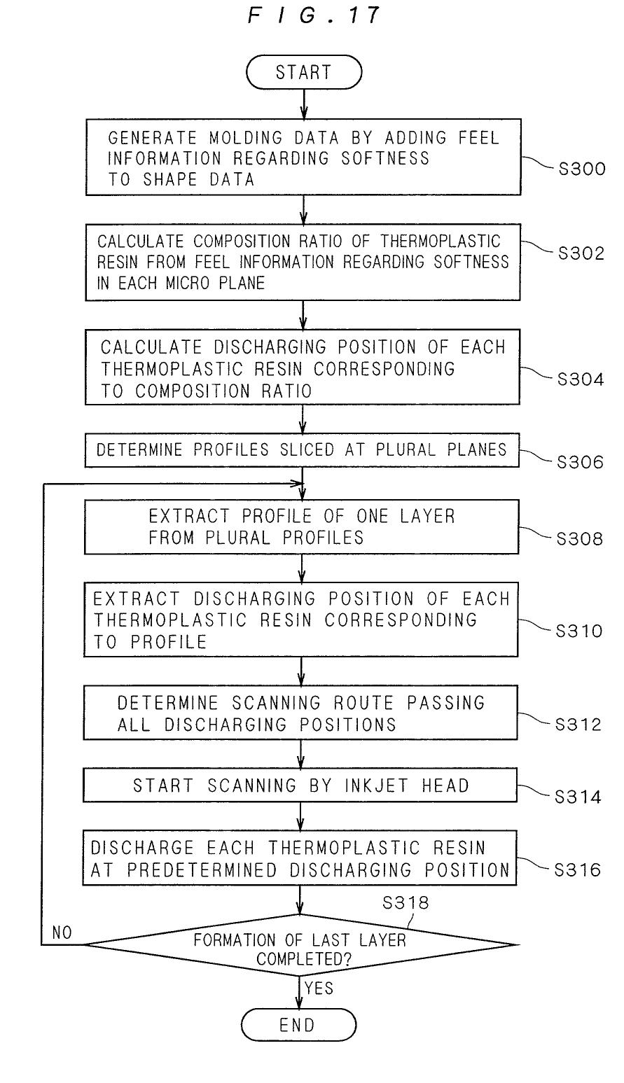

FIG. 17 is a flow chart showing a processing sequence of inkjet molding for reproducing elasticity of a three-dimensional molded matter in the three-dimensional molding system 100.

First, the data generating apparatus 1 adds feel information regarding elasticity (spring constant K) to STL data which is shape data, and the data processing apparatus 10 generates molding data. Then, the molding data is supplied to the controller 21 of the inkjet molding apparatus 40 (step S300). Then, the controller 21 of the inkjet molding apparatus 40 determines a composition ratio of two kinds of resins from the feel information relating elasticity of each micro plane defined in the molding data (step S302).

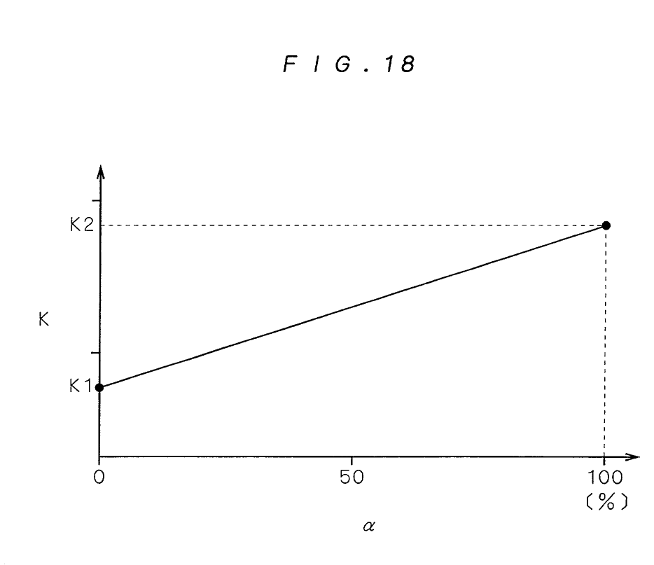

FIG. 18 is a view showing the relationship between composition ratio α of resin material discharged from the nozzle 42a and spring constant K. As shown in FIG. 18, when the three-dimensional molded matter is formed of the resin from the nozzle 42a, the spring constant of the three-dimensional molded matter is realized by K2, and when the three-dimensional molded matter is formed of the resin from the nozzle 42b, the spring constant of the three-dimensional molded matter is realized by K1. Therefore, the controller 21 determines a composition ratio α of the resin material to be discharged from the nozzle 42a based on the value of spring constant K contained in the feel information and the relationship shown in FIG. 18, and then the composition ratio of the resin material to be discharged from the other nozzle 42b is obtained by calculation of β=(100-α). Accordingly, the ratio of resins of the nozzle 42a and the nozzle 42b can be determined as “α:100-α”, so that it is possible to adjust the elasticity of the three-dimensional molded matter at an arbitrary elasticity within the range of K1 to K2.

Then, the controller 21 performs calculation of composition ratio as describe above for each feel information correlated to each micro plane of the molding data to determine the composition ratio for molding for each micro plane.

Incidentally, in the case where strict reproduction of elasticity is not required, only selecting the a resin material which is closer to the spring constant K of the feel information as described above is possible, and in such a case, it is possible to perform molding operation with high efficiency.

Then, based on the composition ratio determined in step S302, the controller 21 determines the positions to which resins are to be discharged from the respective nozzles 42a, 42b (and 42c) (step S304). Then, the controller 21 determines profiles sliced at a plurality of planes to be used in layer-by-layer molding operation from the spatial shape data represented by the molding data (step S306).

Then, the controller 21 forms a space for one layer on the top surface side of the stage 43 or the upper end side of the three-dimensional molded matter 82 by driving the elevator driving section 45, and extracts a profile for one layer which is an object to be molded from the plurality of profiles (step S308). Then, the discharging position of resin from each nozzle corresponding to the extracted profile is extracted (step S310). Then, the controller 21 determines a scanning route of the inkjet head 41 so that each nozzle appropriately passes through all the discharging positions (step S312), and initiates scanning of the inkjet head 41 along the scanning route (step S314).

Then, the controller 21 causes a predetermined resin material from each nozzle when each of the nozzles 42a to 42c are located at appropriate discharging positions while moving the inkjet head 41, thereby performing molding operation for one layer (step S316).

After that, the controlling section judges whether or not formation of the last layer has completed (step S318), and if it is judged “YES” representing that the desired three-dimensional molded matter 82 has completed on the stage 43, the controller 21 terminates the processing, and if it is judged “NO”, the processing of steps S308 to S316 is repeated until formation of the last layer completes.

The three-dimensional molded matter 82 obtained by the above-mentioned processing not only has the same shape as the outer shape of the object to be molded but also has the same elasticity as the object to be molded. That is, since selection or mixture of resin material is made so that the three-dimensional molded matter has elasticity as same as that of the object to be molded, the elasticity of the three-dimensional molded matter is reproduced in the same condition as the object to be molded. Furthermore, in the case where the elasticity of the object to be molded differs depending on the part, the resin material or the composition ratio of resin material is changed for each part of the three-dimensional molded matter 82 corresponding to that part, with the result that also the elasticity of the three-dimensional molded matter 82 is realized to be different depending on the part as in the object to be molded.

Therefore, by applying the above-mentioned processing sequence to the inkjet molding method, it is possible to reproduce the elasticity of the three-dimensional molded matter in the same condition as the elasticity of the object to be molded.

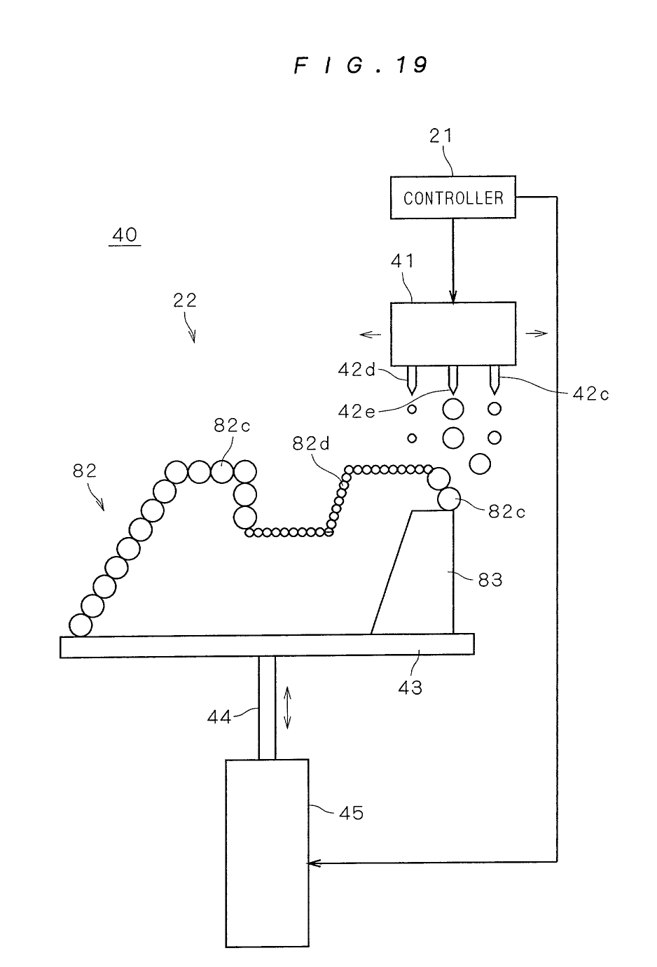

Next, in the case where texture such as touch feel of the object to be molded, as shown in FIG. 19, configuration is made so that a nozzle 42d discharges a fine resin material having a small particle size, and a nozzle 42e discharges a coarse resin material having a large particle size. It is also possible to configure that the nozzle diameter of the nozzle 42d is small and the nozzle diameter of the nozzle 42e is large, thereby varying the size of droplets of resin discharged from the nozzles 42d, 42e. Then, based on the information regarding the feel information (texture information) correlated to each micro plane of the molding data, either one of the nozzle which corresponds or is closer to the texture is selected from the nozzles 42d, 42e. Then, in performing molding operation of that part, by causing the selected nozzle to discharge the resin, it is possible to generate the three-dimensional molded matter 82 having touch feel similar to the texture indicated by the feel information. In the example shown in FIG. 19, assuming that a region 82c of the three-dimensional molded matter 82 is formed of the resin discharged from the nozzle 42d, and a region 82d is formed of the resin discharged from the nozzle 42e, the region 82c of the three-dimensional molded matter 82 is relatively coarse and reproduces a rough feel, while the region 82d of the three-dimensional molded matter 82 reproduces a relatively smooth feel.

Also in this case, if 3 or more nozzles are arranged, and resin materials having different particle sizes are discharged or resins having different droplet sizes are discharged from the respective nozzles, it is possible to reproduce feel of the object to be molded more faithfully by only selecting one nozzle which is closest to the texture information as same as described above.

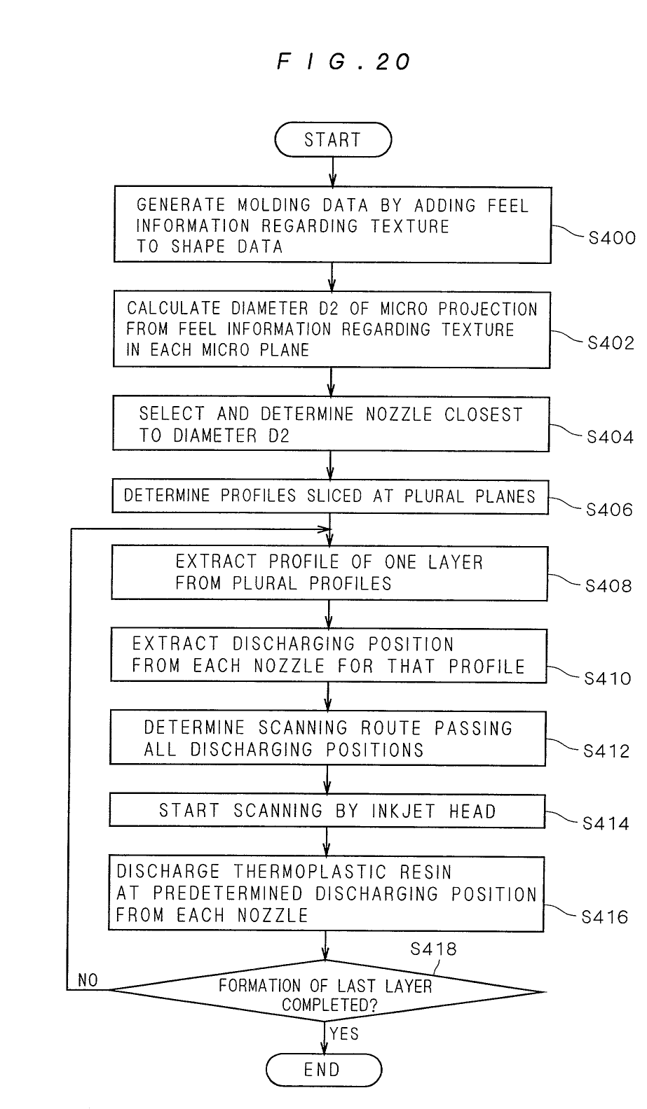

FIG. 20 is a flow chart showing a processing sequence of inkjet molding for reproducing texture such as touch feel of a three-dimensional molded matter in the three-dimensional molding system 100.

First, the data generating apparatus 1 adds feel information regarding the texture (texture information) to STL data which is shape data, and the data processing apparatus 10 generates molding data. Then, the molding data is supplied to the controller 21 of the inkjet molding apparatus 40 (step S400). Then, the controller 21 of the inkjet molding apparatus 40 determines a size of a micro projection and the like (more specifically, diameter D2) for reproducing the texture of that part from the feel information regarding texture (texture information) of each micro plane defined in the molding data by performing a predetermined operational processing (step S402). The operation performed in step S402 is as same as the operation in step S202 of FIG. 11.

Then, the controller 21 selects and determines a nozzle which discharges a resin closest to the diameter D2 determined in step S402 from the nozzles 42d , 42e (step S404). The operation of steps S402, S404 are performed for all the micro planes contained in the molding data, and the nozzle to be used in molding the outer shape of the three-dimensional molded matter is selected and determined. Then the controller 21 determines profiles sliced at a plurality of planes to be used in layer-by-layer molding operation from the spatial shape data represented by the molding data (step S406).

Then, the controller 21 forms a space for one layer on the top surface side of the stage 43 or the upper end side of the three-dimensional molded matter 82 by driving the elevator driving section 45, and extracts a profile for one layer which is an object to be molded from the plurality of profiles (step S408). Then, the discharging position of resin from each nozzle corresponding to the extracted profile is extracted (step S410). Then, the controller 21 determines a scanning route of the inkjet head 41 so that each nozzle appropriately passes through all the discharging positions (step S412), and initiate scanning of the inkjet head 41 along the scanning route (step S414).

Then, the controller 21 causes a predetermined resin material from each nozzle when each of the nozzles 42d, 42e are located at appropriate discharging positions while moving the inkjet head 41, thereby performing molding operation for one layer (step S416).

After that, the controlling section judges whether or not formation of the last layer has completed (step S418), and if it is judged “YES” representing that the desired three-dimensional molded matter 82 has completed on the stage 43, the controller 21 terminates the processing, and if it is judged “NO”, the processing of steps S408 to S416 is repeated until formation of the last layer completes.

The three-dimensional molded matter 82 obtained by the above-mentioned processing not only has the same shape as the outer shape of the object to be molded but also has the same touch feel as the object to be molded by means of the droplets having different sizes discharged on the surface of the molded matter. Furthermore, in the case where the touch feel of the object to be molded differs depending on the part, the size of resin discharged to the surface is changed depending on the part of the three-dimensional molded matter 82 corresponding to that part, with the result that also the touch feel of the three-dimensional molded matter 82 is realized to be different depending on the part as in the object to be molded.

Therefore, by applying the above-mentioned processing sequence to the inkjet molding method, it is possible to reproduce the texture, i.e., touch feel of the three-dimensional molded matter in the same condition as the object to be molded.

In the above description, explanation was made while separating the case of reproducing elasticity of the object to be molded and the case of reproducing texture, however, of course it is possible to reproduce them at the same time. In such a case, configuration is made so that plural kinds of resin materials can be discharged for realizing different elasticities and resins having different sizes can be discharged. And, in addition to determining a kind of resin or a composition ratio to be discharged from the spring constant K, a nozzle from which the resin is to be discharged in formation of the surface side is selected from the texture information. As a result of this, it becomes possible to bring both the elasticity and touch feel of the three-dimensional molded matter into correspondence with those of the object to be molded.

Furthermore, in the inkjet molding apparatus 40, the configuration example that a plurality of nozzles for discharging plural kinds of resins are provided for realizing the elasticity was shown, however, if it is so configured that either one of the resins is selected to be supplied or plural resins are mixed to be supplied in the step of supplying the nozzle with the resin, only one nozzle is required for embodying such a configuration.

Moreover, in this inkjet molding apparatus 40, the configuration example that plural kinds of resins are discharged for realizing the elasticity was shown, however, it is also possible to form a micro hole corresponding to the spring constant K on the inner side of the three-dimensional molded matter as same as the case of the laser molding method. Furthermore, in order to realize the texture, it is possible to form a micro projection corresponding to the texture information on the surface side of the three-dimensional molded matter as same as the case of the laser molding method. With such configuration, it is possible to simplify the configuration of the apparatus because only one kind of resin material and only one nozzle are required.

<4. Powder Molding Method>

Next, three-dimensional molding in the case where the molding method in the molding mechanism section 22 is the powder molding method will be explained.

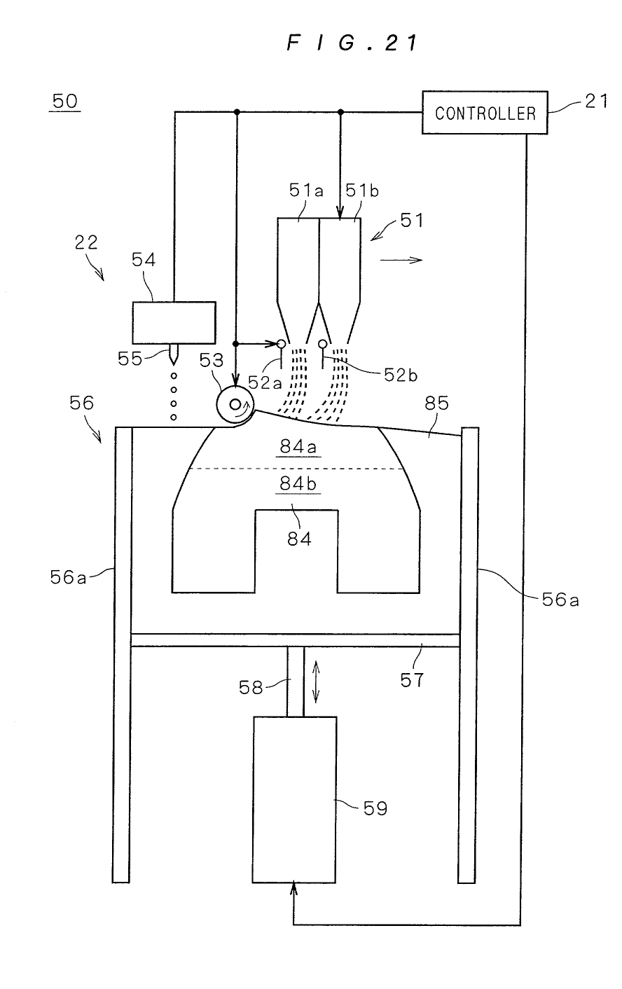

FIG. 21 is a view showing a powder molding apparatus 50 which is a three-dimensional molding apparatus based on the powder molding method. The powder molding apparatus 50 comprises, as the molding mechanism section 22 shown in FIG. 1 or FIG. 5, a molding section 56 for forming a three-dimensional molded matter by overlaying powder; a powder supplying section 51 storing a powder material such as ceramic powder, metal powder, plastic powder and the like, for supplying the material to the molding section 56; an extension roller 53 for causing the powder material supplied to the molding section 56 to be extended, thereby forming a thin layer; and a head portion 54 for discharging an adhesive to the extended thin-layer powder material, thereby causing the powder material to fix in the form corresponding to the molding data.

The molding section 56 is so configured that a stage 57 is provided inside a surrounding wall portion 56a. The stage 57 is supported by a supporting member 58, and an elevator driving section 59 drives the supporting member 58 to move up or down by the controlling section from the controller 21, whereby the stage 57 can be moved up or down at predetermined pitches.

The powder supplying section 51 is provided with two supplying sections 51a, 51b, each supplying section 51a, 51b being formed by a member which is long in the Y direction so as to cover the length in the Y direction of the molding section 56. Also on the lower side of each supplying section 51a, 51b, is provided an opening for supplying the molding section 56 with powder. Therefore, the powder supplying section 51 can accomplish supply of the powder material along all the surface on the top surface side of the molding section 56 by a single movement in the X direction.

Furthermore, the supplying sections 51a, 51b each store powder materials having different properties, and are provided with controlling valves 52a, 52b for controlling supply of the respective powders. The controlling valves 52a, 52b are individually controlled to open/close by the controller 21.

The extension roller 53 has a function of extending a powder material by advancing in the X direction from the rear side of the powder material supplied by the powder supplying section 51, thereby forming a thin layer of uniform thickness.

Furthermore, the head portion 54 has a nozzle 55 for discharging a predetermined adhesive in the form of a micro droplet, and is capable of moving within the XY plane under the control of the controller 21. The head portion 54 supplies the adhesive to a required position for forming a three-dimensional molded matter 84 in the powder layer formed on the top end surface of the molding section 56, thereby fixing the powder material.

In performing three-dimensional molding by means of the powder molding apparatus 50, first, the top surface of the stage 57 is initially set at the position slightly lower than the top end surface of the molding section 56, and under this condition, the powder supplying section 51 is moved in the X direction, the powder material is supplied on the stage 57, and a thin powder layer is formed by the extension roller 53. As a result of this, a powder material for one layer of the three-dimensional molded matter having a micro thickness is supplied on the stage 57. Then, the head 54 discharges an adhesive from above the powder layer to cause a profile of one layer to be fixed, thereby forming a shape of one layer of the three-dimensional molded matter. Then, the stage 57 is moved down by a thickness of one layer, and powder layer is formed thereon so as to form the next one layer, followed by discharge of the adhesive. By repeating such operation, the resin discharged on the stage 57 is cured to sequentially form the three-dimensional molded matter 84, and finally, a complete product of the three-dimensional molded matter 84 is obtained on the stage 57.

Accordingly, in the present preferred embodiment, in molding the three-dimensional molded matter 84, the molding is performed so that feel of the three-dimensional molded matter 84 is as same as that of the object to be molded based on the feel information of the molding data.

For example, in the case of reproducing elasticity such as softness of the object to be molded, the supplying section 51a is filled with a relatively soft powder material, and the supplying section 51b is filled with a relatively hard powder material. Then, on the basis of the information regarding softness which is feel information correlated to each micro plane of the molding data (spring data K), the powder material corresponding to or closer to the elasticity is signified and one of the supplying section is selected from the supplying sections 51a, 51b. Then, in performing molding operation, the selected supplying section is caused to supply the powder material, with the result that it is possible to generate the three-dimensional molded matter 84 having elasticity similar to the elasticity indicated by the feel information. In the example shown in FIG. 21, assuming that an upper part 84a of the three-dimensional molded matter 84 is formed of the powder material supplied from the supplying section 51a, and a lower part 84b is formed of the powder material supplied from the supplying section 51b, the upper part 84a of the three-dimensional molded matter 84 will be formed in a relatively soft condition, and the lower part 84b of the three-dimensional molded matter 84 will be formed in a relatively hard condition.

In FIG. 21, explanation was made for the example where two kinds of powder materials are supplied from two supplying sections 51a, 51b for reproducing feel of the object to be molded, however, by increasing the number of kinds of powder materials to 3 or more, and the number of supplying sections to 3 or more, thereby performing the molding by selecting a powder material having closest softness and the like as described above, it is possible to reproduce the feel of the object to be molded more faithfully.

Furthermore, in the case where an arbitrary elasticity is reproduced in the three-dimensional molded matter 84 by using two kinds of powder materials having different elasticities, if it is so configured that the controller 21 determines a composition ratio of these two kinds of powder materials based on the spring constant K of the feel information, and molding is performed while mixing the two kinds of powder material according to the composition ratio and supplying the mixed powder material, it is possible to generate a three-dimensional molded matter having an elasticity which is in the middle of the elasticities exhibited by the two kinds of powder materials.

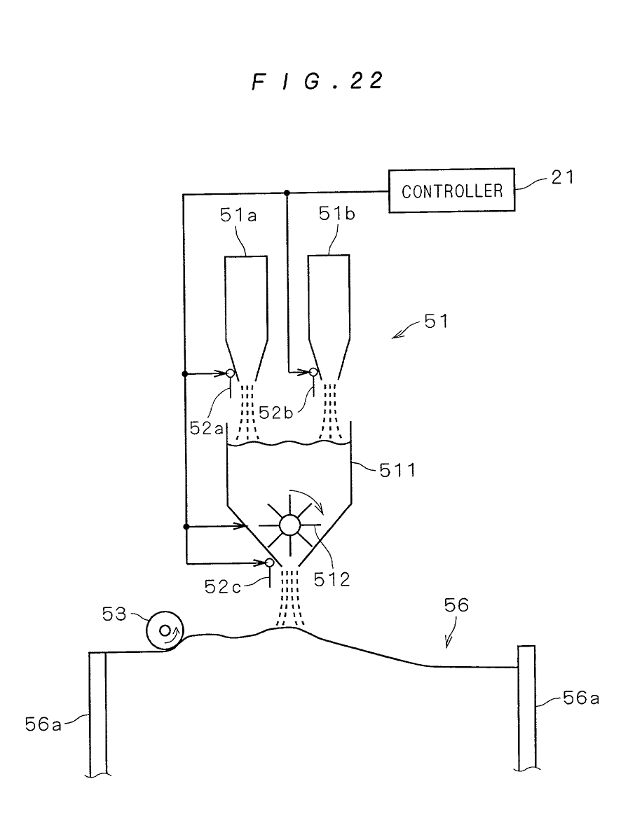

FIG. 22 is a view showing a configuration in which powder materials are mixed for realizing an arbitrary elasticity. As shown in FIG., 22, the powder supplying section 51 has a mixing section 511 on the lower side of the supplying sections 51a, 51b, and also has a stirring roller 512 inside the mixing section 511. Each controller 21 determines a composition ratio of two kinds of powder materials based on the spring constant K, and controls the controlling valves 52a, 52b of the supplying sections 51a, 51b to open/close so as to adapt with the composition ratio, thereby supplying the mixing section 511 with two kinds of powder materials. Then, after making the stirring roller 512 of the mixing section 511 operate for stirring the two kinds of powder materials, the controller 21 opens the controlling valve 52c provided in the mixing section 511 to supply the molding section 56 with the powder material. The powder material supplied at this time is adapted to the above composition ratio, and hence the composition ratio of powder material per unit volume is also adjusted, with the result that a three-dimensional molded matter having arbitrary elasticity is reproduced.

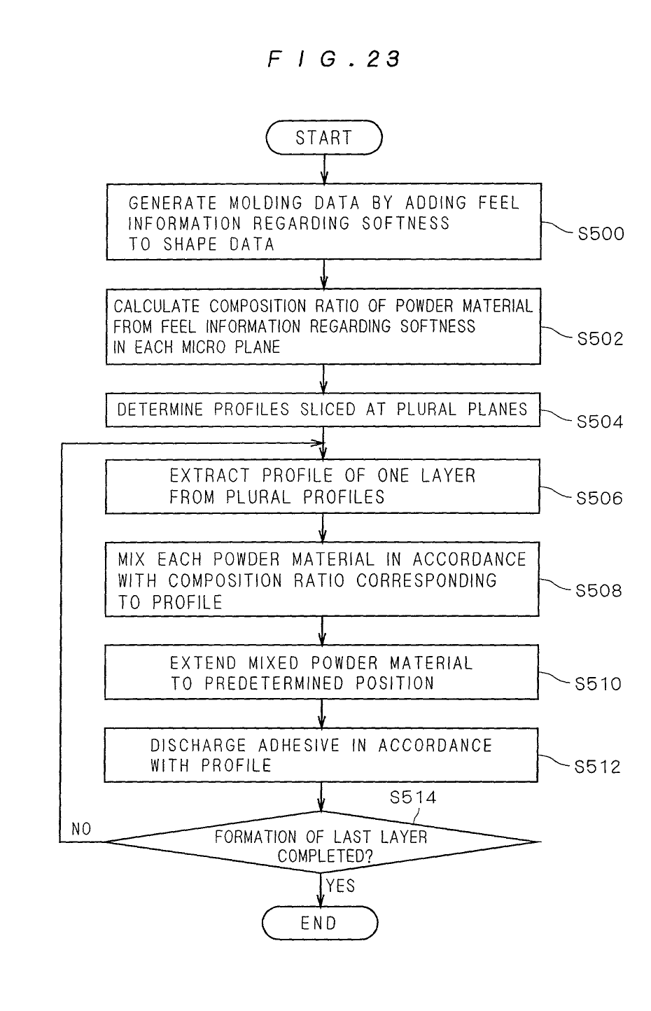

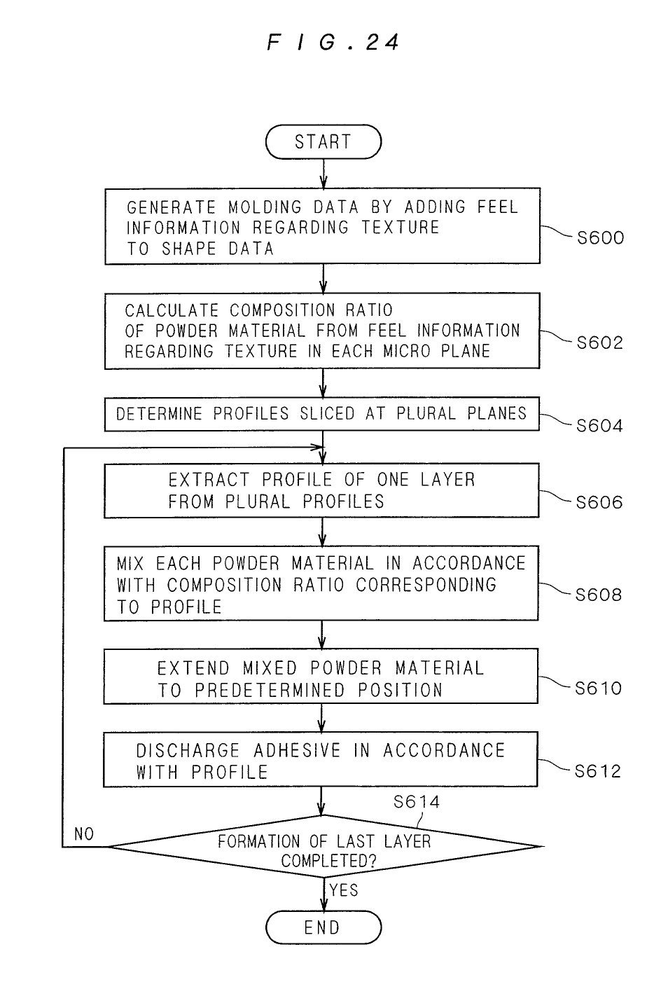

FIG. 23 is a flow chart showing a processing sequence of powder molding for reproducing elasticity of a three-dimensional molded matter in the three-dimensional molding system 100.

First, the data generating apparatus 1 adds feel information regarding the softness, i.e., elasticity of the object to be molded (spring constant K) to STL data which is shape data, and the data processing apparatus 10 generates molding data. Then, the molding data is supplied to the controller 21 of the powder molding apparatus 50 (step S500). Then, the controller 21 of the powder molding apparatus 50 determines a composition ratio of two kinds of resins from the feel information regarding elasticity of each micro plane defined in the molding data (step S502). The way of determining this composition ratio is as same as in step S302 of FIG. 17. The controller 21 performs calculation of composition ratio as describe above for each feel information correlated to each micro plane of the molding data to determine the composition ratio for molding for each micro plane.

Incidentally, in the case where strict reproduction of elasticity is not required, only selecting the a powder material which is closer to the spring constant K of the feel information as described above is possible, and in such a case, it is possible to perform molding operation with high efficiency.

Then, the controller 21 determines profiles sliced at a plurality of planes to be used in layer-by-layer molding operation from the spatial shape data represented by the molding data (step S504). This profile represents a region to which an adhesive is to be discharged.

Then, the controller 21 forms a space for one layer on the top surface side of the stage 57 or the upper end side of the three-dimensional molded matter 84 by driving the elevator driving section 59, and extracts a profile for one layer which is an object to be molded from the plurality of profiles (step S506). Then, the controller 21 mixes a plurality of powder materials in the mixing section 511 according to the composition ratio (step S508), supplies the mixed powder material to a predetermined position, and forms a powder layer by the extension roller 53 (step S510). Then, the controller 21 drives the head portion 54, discharges an adhesive in correspondence to the profile, and fixes the powder material of the part corresponding to the profile (step S512).

After that, the controlling section judges whether or not formation of the last layer has completed (step S514), and if it is judged “YES” representing that the desired three-dimensional molded matter 84 has completed on the stage 57, the controller 21 terminates the processing, and if it is judged “NO”, the processing of steps S506 to S512 is repeated until formation of the last layer completes.

The three-dimensional molded matter 84 obtained by the above-mentioned processing not only has the same shape as the outer shape of the object to be molded but also has the same elasticity as the object to be molded. That is, since selection or mixture of powder material is made so that the three-dimensional molded matter has elasticity as same as that of the object to be molded, the elasticity of the three-dimensional molded matter is reproduced in the same condition as the object to be molded. Furthermore, in the case where the elasticity of the object to be molded differs depending on the part, the powder material or the composition ratio of powder material is changed for each part of the three-dimensional molded matter 84 corresponding to that part, with the result that also the elasticity of the three-dimensional molded matter 84 is realized to be different depending on the part as in the object to be molded.

Therefore, by applying the above-mentioned processing sequence to the powder molding method, it is possible to reproduce the elasticity of the three-dimensional molded matter in the same condition as the elasticity of the object to be molded.

Next, in the case where texture such as touch feel of the object to be molded, configuration is made so that the supplying portion 51a discharges a powder material having a small particle size, and the supplying portion 51b discharges a powder material having a large particle size. Then, based on the feel information (texture information) correlated to each micro plane of the molding data, either one of the supplying section which corresponds or is closer to the texture is selected. Then, in performing molding operation, by causing the selected supplying section to discharge the powder material, it is possible to generate the three-dimensional molded matter 84 having touch feel similar to the texture indicated by the feel information. In the example shown in FIG. 21, assuming that a region 84a of the three-dimensional molded matter 84 is formed of the powder material discharged from the supplying section 51a, and a region 84b is formed of the powder material discharged from the supplying section 51b, the region 84b of the three-dimensional molded matter 84 is relatively coarse and reproduces a rough feel, while the region 84a of the three-dimensional molded matter 82 reproduces a relatively smooth feel.

Also in this case, if 3 or more nozzles are arranged, and powder materials having different particle sizes are discharged from the respective supplying sections, it is possible to reproduce feel of the object to be molded more faithfully by only selecting one supplying section which is closest to the texture information as same as described above.

FIG. 23 is a flow chart showing a processing sequence of powder molding for reproducing texture such as touch feel of a three-dimensional molded matter in the three-dimensional molding system 100.

First, the data generating apparatus 1 adds feel information regarding the texture (texture information) to STL data which is shape data, and the data processing apparatus 10 generates molding data. Then, the molding data is supplied to the controller 21 of the powder molding apparatus 50 (step S600). Then, the controller 21 of the powder molding apparatus 50 calculates a composition ratio of powder material for realizing the texture of the part from the feel information regarding texture (texture information) of each micro plane defined in the molding (step S602). The calculation at this step is achieved by determining a size of powder material (more specifically, diameter D2) from the texture information by performing a predetermined operation, and determining a composition ratio of powder materials having different sizes so that the average size of the powder material per unit volume is equal to the diameter D2 determined by the operation. This operation is performed for all the micro planes contained in the molding data.

Then the controller 21 determines profiles sliced at a plurality of planes to be used in layer-by-layer molding operation from the spatial shape data represented by the molding data (step S604).

Then, the controller 21 forms a space for one layer on the top surface side of the stage 57 or the upper end side of the three-dimensional molded matter 84 by driving the elevator driving section 59, and extracts a profile for one layer which is an object to be molded from the plurality of profiles (step S606). Then, the controller 21 mixes a plurality of powder materials in the mixing section 511 according to the composition ratio (step S608), supplies the mixed powder material to a predetermined position, and forms a powder layer by the extension roller 53 (step S610). Then, the controller 21 drives the head portion 54, discharges an adhesive in correspondence to the profile, and fixes the powder material of the part corresponding to the profile (step S612).

After that, the controlling section judges whether or not formation of the last layer has completed (step S614), and if it is judged “YES” representing that the desired three-dimensional molded matter 84 has completed on the stage 57, the controller 21 terminates the processing, and if it is judged “NO”, the processing of steps S606 to S612 is repeated until formation of the last layer completes.

The three-dimensional molded matter 84 obtained by the above-mentioned processing not only has the same shape as the outer shape of the object to be molded but also has the same touch feel as the object to be molded by means of the powder materials having different sizes discharged on the surface of the molded matter. Furthermore, in the case where the touch feel of the object to be molded differs depending on the part, the size of powder material discharged to the surface is changed depending on the part of the three-dimensional molded matter 84 corresponding to that part, with the result that also the touch feel of the three-dimensional molded matter 84 is realized to be different depending on the part as in the object to be molded.

Therefore, by applying the above-mentioned processing sequence to the powder molding method, it is possible to reproduce the texture, i.e., touch feel of the three-dimensional molded matter in the same condition as the that of the object to be molded.

In the above description, explanation was made separately for the case of reproducing elasticity of the object to be molded and the case of reproducing texture, however, of course, it is possible to reproduce them at the same time. In such a case, configuration is made so that plural kinds of powder materials can be discharged for realizing different elasticities and that powder materials of different sizes can be discharged. And, in addition to determining a kind of powder material or a composition ratio to be supplied from the spring constant K, the size of the powder material to be supplied is determined from texture information. As a result of this, it becomes possible to bring both the elasticity and touch feel of the three-dimensional molded matter into correspondence with those of the object to be molded.

Furthermore, in the powder molding apparatus 50, the configuration where plural kinds of resins are discharged for realizing the elasticity was exemplified, however, it is also possible to form a micro hole corresponding to the spring constant K on the inner side of the three-dimensional molded matter as same as in the case of the laser molding method. Furthermore, in order to realize the texture, it is possible to form a micro projection corresponding to the texture information on the surface side of the three-dimensional molded matter as same as in the case of the laser molding method. With such configuration, it is possible to simplify the configuration of the apparatus because only one kind of resin material and only one kind of powder material are required.

In the above, the feel of the three-dimensional molded matter is reproduced as same as that of the object to be molded by means of the kind of powder material in the powder molding apparatus 50, however, in the case of the powder molding method, it is also possible to vary the feel by changing the kind of adhesive. The configuration of the apparatus for this case is shown in FIG. 25.

As shown in FIG. 25, this powder molding apparatus 50a has the powder supplying section 51 storing one kind of powder material, for supplying the molding section 56 with the powder material, and after extending the powder material supplied to the molding section 56 by means of the extension roller 53, different kinds of adhesives are discharged from two nozzles 55a, 55b provided in the head portion 54.

Then, in reproducing the elasticity of the object to be molded in the three-dimensional molded matter, the nozzle 55a discharges an adhesive which will be relatively soft when dried, and the nozzle 55b discharges an adhesive which will be relatively hard when dried, and the adhesive is selectively discharged in accordance with the spring constant K contained in the molding data. Consequently, it is possible to reproduce the elasticity of the three-dimensional molded matter in the same condition as the elasticity of the object to be molded.

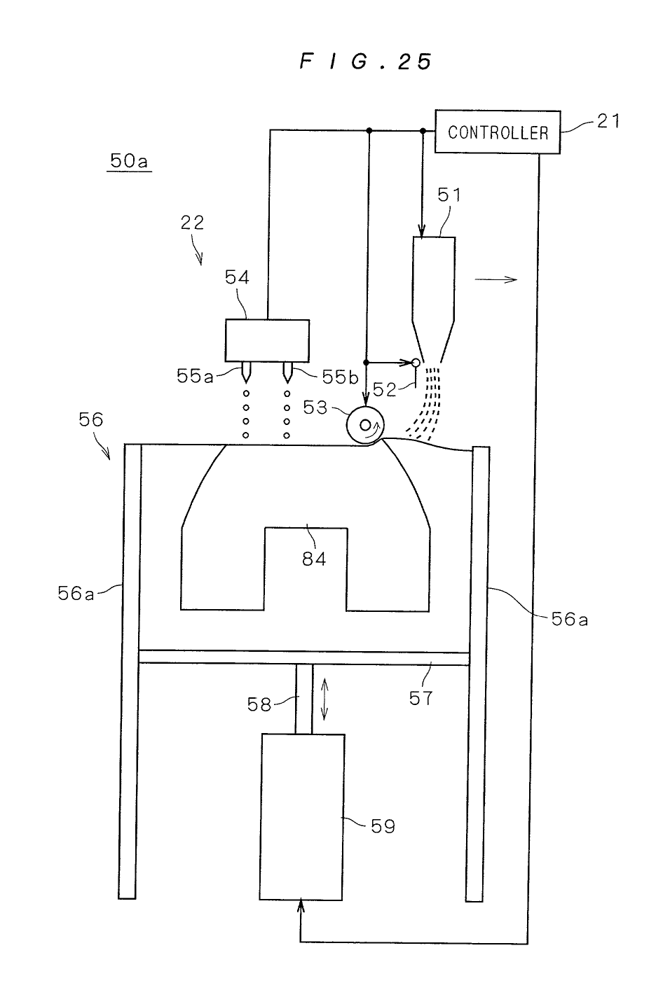

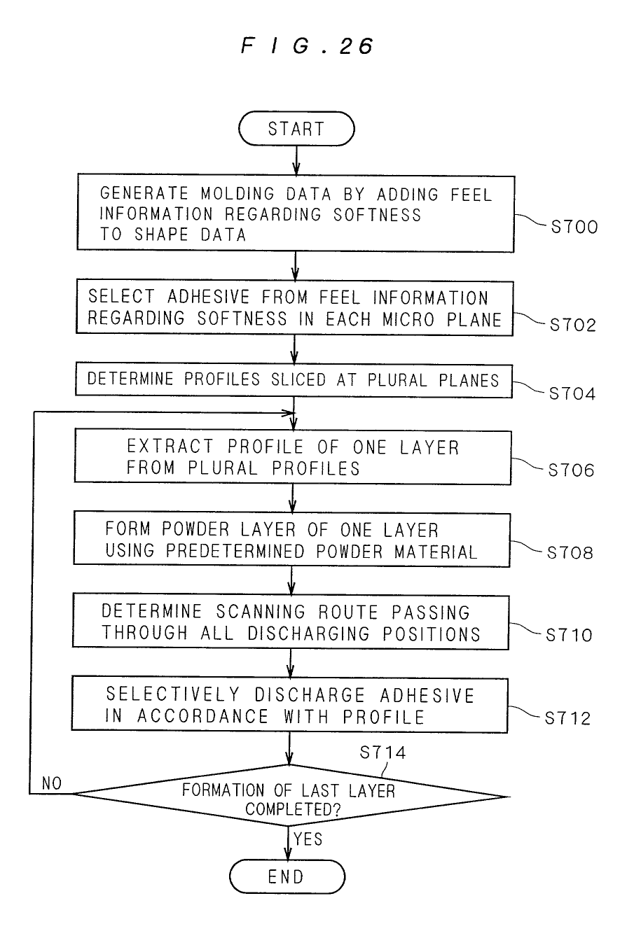

FIG. 26 is a flow chart showing a processing sequence of powder molding for this case.

First, the data generating apparatus 1 adds feel information regarding the softness, i.e., elasticity of the object to be molded (spring constant K) to STL data which is shape data, and the data processing apparatus 10 generates molding data. Then, the molding data is supplied to the controller 21 of the powder molding apparatus 50a (step S700). Then, the controller 21 of the powder molding apparatus 50a selects an adhesive to be used from the feel information regarding elasticity of each micro plane defined in the molding data (step S702).

Then, the controller 21 determines profiles sliced at a plurality of planes to be used in layer-by-layer molding operation from the spatial shape data represented by the molding data (step S704). This profile represents a region to which an adhesive is to be discharged.

Then, the controller 21 forms a space for one layer on the top surface side of the stage 57 or the upper end side of the three-dimensional molded matter 84 by driving the elevator driving section 59, and extracts a profile for one layer which is an object to be molded from the plurality of profiles (step S706). Then, the controller 21 forms a powder layer of one layer on the molding section 56 using a predetermined powder material (step S708). Then, the controller 21 determines all discharging positions of adhesives while moving the head portion 54, and determines a scanning route that passes through all of the discharging positions (step S710). Then, the controller 21 drives the head portion 54, selectively discharges an adhesive in accordance with the profile, and fixes the powder material of the part corresponding to the profile (step S712).

After that, the controlling section judges whether or not formation of the last layer has completed (step S714), and if it is judged “YES” representing that the desired three-dimensional molded matter 84 has completed on the stage 57, the controller 21 terminates the processing, and if it is judged “NO”, the processing of steps S706 to S712 is repeated until formation of the last layer completes.

The three-dimensional molded matter 84 obtained by the above-mentioned processing not only has the same shape as the outer shape of the object to be molded but also has the same elasticity as the object to be molded. Furthermore, in the case where the elasticity of the object to be molded differs depending on the part, the selection of adhesive to be discharged is changed for each part of the three-dimensional molded matter 84 corresponding to that part, with the result that also the elasticity of the three-dimensional molded matter 84 is realized to be different depending on the part as in the object to be molded.

Therefore, by applying the above-mentioned processing sequence to the powder molding method, it is possible to reproduce the elasticity of the three-dimensional molded matter in the same condition as the elasticity of the object to be molded.

Then, in reproducing the elasticity of the object to be molded in the three-dimensional molded matter, the nozzle 55a discharges an adhesive which will have a relatively rough feel when dried, and the nozzle 55b discharges an adhesive which will have a relatively smooth feel when dried, and the adhesive is selectively discharged in accordance with the texture information contained in the molding data. Accordingly, it is possible to reproduce the elasticity of the three-dimensional molded matter in the same condition as the elasticity of the object to be molded.

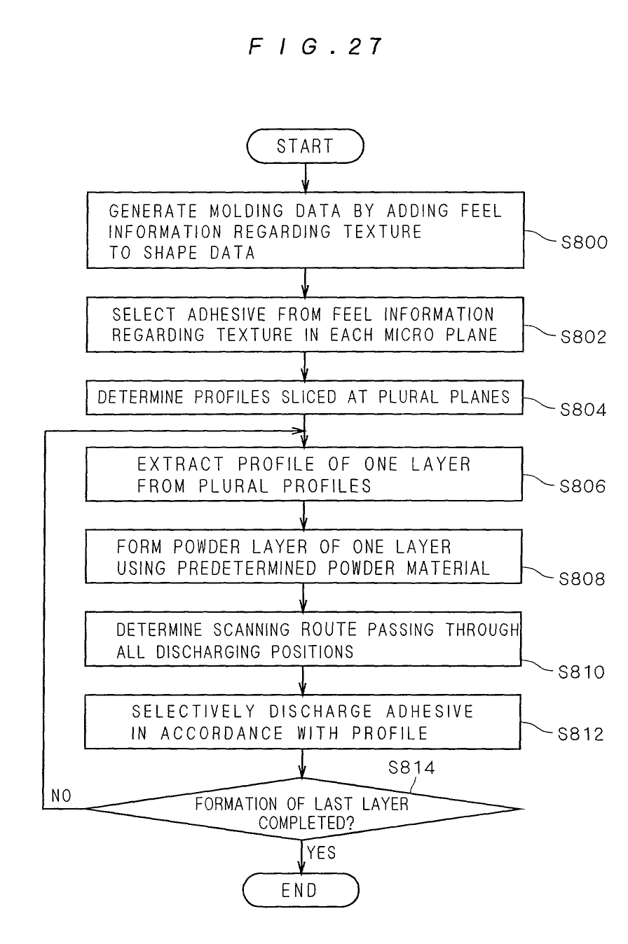

FIG. 27 is a flow chart showing a processing sequence of powder molding for this case.

First, the data generating apparatus 1 adds feel information regarding the texture of the object to be molded (texture information) to STL data which is shape data, and the data processing apparatus 10 generates molding data. Then, the molding data is supplied to the controller 21 of the powder molding apparatus 50a (step S800). Then, the controller 21 of the powder molding apparatus 50a selects an adhesive to be used from the feel information regarding texture of each micro plane defined in the molding data (step S802).

Then, the controller 21 determines profiles sliced at a plurality of planes to be used in layer-by-layer molding operation from the spatial shape data represented by the molding data (step S804). This profile represents a region to which an adhesive is to be discharged.

Then, the controller 21 forms a space for one layer on the top surface side of the stage 57 or the upper end side of the three-dimensional molded matter 84 by driving the elevator driving section 59, and extracts a profile for one layer which is an object to be molded from the plurality of profiles (step S806). Then, the controller 21 forms a powder layer of one layer on the molding section 56 using a predetermined powder material (step S808). Then, the controller 21 determines all discharging positions of adhesives while moving the head portion 54, and determines a scanning route that passes through all of the discharging positions (step S810). Then, the controller 21 drives the head portion 54, selectively discharges an adhesive in accordance with the profile, and fixes the powder material of the part corresponding to the profile (step S812).

After that, the controlling section judges whether or not formation of the last layer has completed (step S814), and if it is judged “YES” representing that the desired three-dimensional molded matter 84 has completed on the stage 57, the controller 21 terminates the processing, and if it is judged “NO”, the processing of steps S806 to S812 is repeated until formation of the last layer completes.

The three-dimensional molded matter 84 obtained by the above-mentioned processing not only has the same shape as the outer shape of the object to be molded but also has the same touch feel as the object to be molded. Furthermore, in the case where the touch feel of the object to be molded differs depending on the part, the selection of adhesive to be discharged is changed for each part of the three-dimensional molded matter 84 corresponding to that part, with the result that also the touch feel of the three-dimensional molded matter 84 is realized to be different depending on the part as in the object to be molded.

Therefore, by applying the above-mentioned processing sequence to the powder molding method, it is possible to reproduce the touch feel of the three-dimensional molded matter in the same condition as the touch feel of the object to be molded.

If it is so configured that feel of the object to be molded is reproduced in the three-dimensional molded matter by selecting the adhesive, as described above, the supplying form of the powder material is not necessarily be the form as shown in FIG. 25.

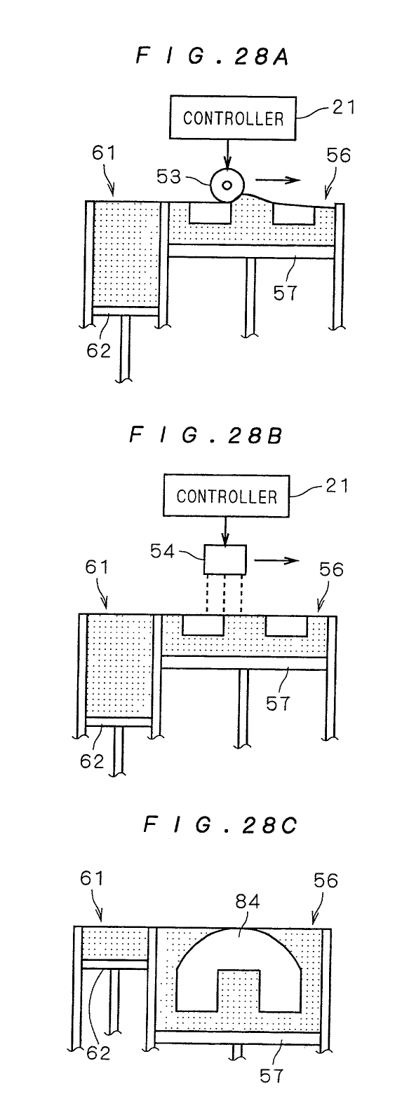

FIGS. 28A to 28C show molding operation in schematic in the case where a powder supplying section 61 for storing and supplying powder material is provided on the side of the molding section 56. As shown in FIG. 28A, a stage 62 for pushing up powder material is provided at the bottom of the powder supplying section 61, and the stage 62 moves up by a predetermined amount to supply the powder material in the traverse direction of the molding section 56 in heaped-up shape. Then, the extension roller 53 extends the powder material on the top surface side of the molding section 56 from the powder supplying section 61, thereby forming a powder layer of one layer. Then, as shown in FIG. 28B, the head 54 is moved and the adhesive is selectively discharged, thereby fixing the profile part and reproducing the feel. By repeating such operation, it is possible to generate a complete product of the three-dimensional molded matter 84 on the molding section 56 as shown in FIG. 28C.

<5. Alternative Example>

In the above, preferred embodiments of the present invention have been explained, however, the present invention is not limited to the above description.

For example, the above explanation was made while taking the laser molding method, inkjet molding method and powder molding method as examples, however, it goes without saying that also other molding methods can be applied.

While the invention has been shown and described in detail, the foregoing description is in all aspects illustrative and not restrictive. It is therefore understood that numerous other modifications and variations can be devised without departing from the scope of the invention.

What is claimed is:

1. A three-dimensional molding apparatus comprising:
an acquiring section for acquiring data for molding a three-dimensional object, said data including information regarding shape of said three-dimensional object and information regarding feel of each part of said three-dimensional object;
a molding section for molding a three-dimensional molded matter using a predetermined material; and
a controller for controlling said molding section so as to mold said three-dimensional object which reproduces said shape and said feel on the basis of said data acquired by said acquiring section.

2. A data processing apparatus for generating molding data to be used in three-dimensional molding, comprising:
a shape data inputting section for inputting shape data regarding shape of an object;
a feel information acquiring section for acquiring feel information regarding texture of said object; and
a data generating section for generating molding data for reproducing shape and feel of said object on the basis of said shape data and said feel information.

3. The data processing apparatus according to claim 2, wherein
said data generating section generates said molding data by transforming the shape represented by said shape data on the basis of said feel information.

4. The data processing apparatus according to claim 2, wherein
said feel information is information obtained by measuring feel of said object.

5. A data processing apparatus comprising:
a shape data inputting section for inputting shape data regarding shape of an object:
a feel information acquiring section for acquiring feel information regarding feel of said object; and
a memory for storing said shape data and said feel information in correlation with each other.

6. The data processing apparatus according to claim 5, wherein
said feel information is information obtained by measuring feel of said object.

7. The data processing apparatus according to claim 5, wherein
said feel information has information regarding feel for each of plural parts of said object.

8. The data processing apparatus according to claim 5, wherein
said feel information has at least one of information regarding softness of said object and information regarding texture of said object as said information regarding feel.

9. A three-dimensional molding apparatus for generating a three-dimensional molded matter of an object, comprising:
a molding section for molding said three-dimensional molded matter; and
a controller for controlling said molding section on the basis of shape data regarding shape of said object and feel information regarding feel of said object.

10. The three-dimensional molding apparatus according to claim 9, wherein
said feel information is information regarding softness of said object, and
said controller forms a hollow portion of the size corresponding to said softness on the inner side of said three-dimensional molded matter.

11. The three-dimensional molding apparatus according to claim 9, wherein
said feel information is information regarding softness of said object, and
said three-dimensional molded matter is formed of a material having a property corresponding to said softness.

12. The three-dimensional molding apparatus according to claim 9, wherein
said feel information is information regarding texture of said object, and
said controller forms a micro projection having a size corresponding to said texture on the surface of said three-dimensional molded matter.

13. The three-dimensional molding apparatus according to claim 9, wherein
said feel information is information regarding texture of said object, and
said three-dimensional molded matter is formed of a material having a property corresponding to said texture.

14. The three-dimensional molding apparatus according to claim 9, wherein
said molding section generates said three-dimensional molded matter by a laser molding method, and generates said three-dimensional molded matter by controlling drive of predetermined laser light.

15. The three-dimensional molding apparatus according to claim 9, wherein
said molding section generates said three-dimensional molded matter by an inkjet molding method, and generates said three-dimensional molded matter by controlling an injection material from a predetermined inkjet nozzle.

16. The three-dimensional molding apparatus according to claim 9, wherein
said molding section generates said three-dimensional mold by an inkjet molding method, and generates said three-dimensional molded matter by controlling to select an inkjet nozzle to be used for discharging ink from a plurality of inkjet nozzles.

17. The three-dimensional molding apparatus according to claim 9, wherein
said molding section generates said three-dimensional molded matter by a powder molding method, and generates said three-dimensional molded matter by selecting or mixing powder material to be used in molding from a plurality of powder materials.

18. The three-dimensional molding apparatus according to claim 9, wherein
said molding section generates said three-dimensional molded matter by a powder molding method, and generates said three-dimensional molded matter by controlling application of an adhesive for bonding a predetermined powder material.

19. The three-dimensional molding apparatus according to claim 9, wherein
said feel information has information regarding feel for each of plural parts of said object.

20. The three-dimensional molding apparatus according to claim 19, wherein
said feel information has at least one of information regarding softness of said object and information regarding texture of said object as the information regarding texture.

21. A data processing method comprising the steps of:
inputting shape data regarding shape of an object;
inputting feel information regarding feel of said object; and
storing said shape data and said feel information in correlation with each other.

22. A data processing method for generating molding data to be used in three-dimensional molding, comprising the steps of:
inputting shape data regarding shape of an object;
inputting feel information regarding feel of said object; and
generating said molding data for reproducing shape and feel of said object on the basis of said shape data and said feel information.

23. A three-dimensional molding method for generating a three-dimensional molded matter of an object, comprising the steps of:
inputting shape data regarding shape of said object and feel information regarding feel of said object; and
generating said three-dimensional molded matter by controlling predetermined molding means on the basis of said shape data and said feel information.

24. Molding data to be used in three-dimensional molding, having data structure in which shape data relating shape of an object and feel information regarding feel of said object are correlated with each other.

25. The molding data according to claim 24, wherein
said feel information has information regarding feel for each of plural parts of said object.

26. The molding data according to claim 25, wherein
said feel information has at least one of information regarding softness of said object and information regarding texture of said object as the information regarding feel.
